(19) United States
(12) Patent Application Publication
(10) Pub. No.: US 2025/0068666 A1
(43) Pub. Date: Feb. 27, 2025

(54) INTERACTIVE MAP-BASED VISUALIZATION SYSTEM RELATED TO MULTI-CHANNEL SEARCH FOR COMPLEX SEARCH DOMAINS

(71) Applicant: Optum, Inc., Minnetonka, MN (US)

(72) Inventors: Harsh M. Maheshwari, Irving, TX (US); Yizhao Ni, Centennial, CO (US); Cem Unsal, Alameda, CA (US); Ramin Anushiravani, San Carlos, CA (US)

(21) Appl. No.: 18/520,662

(22) Filed: Nov. 28, 2023

Related U.S. Application Data
(60) Provisional application No. 63/578,463, filed on Aug. 24, 2023.

(51) Int. Cl. G06F 16/338; G06F 16/383; G06F 16/387

(52) U.S. Cl. CPC G06F 16/338; G06F 16/383; G06F 16/387

(57) ABSTRACT

Various embodiments of the present disclosure provide an interactive map-based visualization system related to multi-channel search for search domains to improve upon traditional search resolutions within such domains. The techniques may include receiving a user interface request that comprises (i) character-level text input related to a search query via a user interface of a user device and (ii) filter metadata for a user identifier associated with the user interface request, generating a set of query result data objects for the user interface request by correlating the character-level text input to at least one domain knowledge profile, and generating a set of filtered query result data objects for the user interface request by filtering the set of query result data objects using the filter metadata. In some examples, the techniques may include initiating a rendering of a set of selectable graphical element options that are correlated to a real-time map visualization.

### CROSS-REFERENCE TO RELATED APPLICATIONS

This application claims the benefit of U.S. Provisional Application No. 63/578,463, entitled “SMART INTERACTIVE MAP-BASED PROVIDER LOOKUP,” and filed Aug. 24, 2023, the entire contents of which are hereby incorporated by reference.

### BACKGROUND

Various embodiments of the present disclosure address technical challenges related to search query resolutions generally and, more specifically, for generating comprehensive query resolutions for complex search domains. Traditionally, query resolutions are retrieved using basic keyword searching techniques on limited search result features, such as provider names, addresses, specialties, and/or the like for a clinical domain. In some cases, these searches may be augmented with primitive structured filters, such as provider spoken languages, distances, and/or the like, to narrow down returned results. In such cases, a user is required to fill in a lengthy form (e.g., one or more input fields, etc.) to complete a search query, and very often, the search is not effective because the user lacks sufficient knowledge for a particular search domain (e.g., a user may not know what clinical specialty is needed for a condition, etc.). By way of example, in a clinical domain, a user's child may experience stomach pain for one week causing a user to look for a provider to treat the condition. However, the user may not understand the condition or provider specialties enough to search or recognize a correct provider. As such, the user may enter a search query indicative (e.g., including identifiers, such as international classification of diseases (ICD) codes, textual descriptions of a condition, etc.) of the condition, such as the natural language text sequence “my kid's stomach hurts all the time” and constrain the results to providers within 50 miles from the user's home. Such a search query may result in null results due to a lack of keyword matches between provider features and the keywords “stomach” and “hurts.” As shown by the example, traditional searching techniques are limited to user's with sufficient knowledge of a search domain.

Even if comprehensive search results are achievable, traditional systems fail to provide such information in a consumable manner. This leads to wasted computing resources devoted to search results that are generated but then buried to the user behind other less relevant results. For example, traditional user interfaces provide static results in a list form based on a search query. The list of results lacks contextual information sufficient to derive any meaning from the result unless it is interacted with. This leads vast expenditures of time and computing resources as users interact with multiple irrelevant search results before finding one that sufficiently satisfies the query. Traditionally, in the event that no search result satisfies a query, a user is forced to restart the search process with an entirely new query.

Various embodiments of the present disclosure make important contributions to traditional search query resolution techniques by addressing this technical challenge, among others.

### BRIEF SUMMARY

Various embodiments of the present disclosure provide multi-modal and multi-channel search solutions and accompanying user interfaces to intelligently enhance search queries and aggregate multi-channel results for a search query that enable comprehensive query resolutions for generic search results. Using some of the techniques of the present disclosure, a search query may be transformed into multiple complementary representations, such as a keyword and embedding representation, to measure a syntactic and sematic similarity between the search query and features across multiple domain channels of a search domain. These measures may be aggregated to identify multi-channel features that correspond to the search query, which may be used to identify and/or augment a final search resolution. In this way, some of the techniques of the present disclosure provide searching capabilities with deeper semantic and contextual understanding of search queries beyond literal words (e.g., interpreting “stomach hurts” as “stomach pain” or more general, “upper abdominal pain”).

In some embodiments, these search capabilities enable comprehensive search results in response to a query. If supplied by traditional user interfaces, some of the comprehensive search results may be lost or ignored by a user. Using some of the techniques of the present disclosure, a user interface and/or a user device associated therewith may be additionally or alternatively improved by optimizing presentation of visual data via the user interface and/or by minimizing a number of user interactions with respect to the user interface, thereby reducing a number of computing resources utilized by the user device. In some embodiments, a visual data for the user interface may be optimally rendered based on a size and/or hardware functionality of a display associated with the user interface.

In some embodiments, a computer-implemented method includes receiving, by one or more processors, a user interface request that comprises (i) character-level text input related to a search query via a user interface of a user device and (ii) filter metadata for a user identifier associated with the user interface request. In some embodiments, the computer-implemented method additionally or alternatively includes generating, by the one or more processors, a set of query result data objects for the user interface request by correlating the character-level text input to at least one domain knowledge profile. In some embodiments, the computer-implemented method additionally or alternatively includes generating, by the one or more processors, a set of filtered query result data objects for the user interface request by filtering the set of query result data objects using the filter metadata. In some embodiments, the computer-implemented method additionally or alternatively includes initiating, by the one or more processors and via the user interface of the user device, a rendering of a set of selectable graphical element options that are correlated to a real-time map visualization and indicative of the set of filtered query result data objects.

In some embodiments, a computing system includes memory and one or more processors communicatively coupled to the memory. In some embodiments, the one or more processors are configured to receive a user interface request that comprises (i) character-level text input related to a search query via a user interface of a user device and (ii) filter metadata for a user identifier associated with the user interface request. In some embodiments, the one or more processors are additionally or alternatively configured to generate a set of query result data objects for the user interface request by correlating the character-level text input to at least one domain knowledge profile. In some embodiments, the one or more processors are additionally or alternatively configured to generate a set of filtered query result data objects for the user interface request by filtering the set of query result data objects using the filter metadata. In some embodiments, the one or more processors are additionally or alternatively configured to initiate, via the user interface of the user device, a rendering of a set of selectable graphical element options that are correlated to a real-time map visualization and indicative of the set of filtered query result data objects.

In some embodiments, one or more non-transitory computer-readable storage media include instructions that, when executed by one or more processors, cause the one or more processors to receive a user interface request that comprises (i) character-level text input related to a search query via a user interface of a user device and (ii) filter metadata for a user identifier associated with the user interface request. In some embodiments, the instructions, when executed by the one or more processors, additionally or alternatively cause the one or more processors to generate a set of query result data objects for the user interface request by correlating the character-level text input to at least one domain knowledge profile. In some embodiments, the instructions, when executed by the one or more processors, additionally or alternatively cause the one or more processors to generate a set of filtered query result data objects for the user interface request by filtering the set of query result data objects using the filter metadata. In some embodiments, the instructions, when executed by the one or more processors, additionally or alternatively cause the one or more processors to initiate, via the user interface of the user device, a rendering of a set of selectable graphical element options that are correlated to a real-time map visualization and indicative of the set of filtered query result data objects.

### BRIEF DESCRIPTION OF DRAWINGS

FIG. 1 illustrates an example computing system in accordance with one or more embodiments of the present disclosure.

FIG. 2 is a schematic diagram showing a system computing architecture in accordance with one or more embodiments of the present disclosure.

FIG. 3 is a system diagram showing an example query resolution system in accordance with some embodiments discussed herein.

FIG. 4 is a dataflow diagram showing example data structures and modules for generating a query resolution in accordance with some embodiments discussed herein.

FIG. 5 illustrates an example interactive map-based visualization system in accordance with one or more embodiments of the present disclosure.

FIG. 6 illustrates an example user interface for providing an interactive map-based visualization related to a query search in accordance with one or more embodiments of the present disclosure.

FIG. 7 illustrates an example user interface element for providing entity information related to a selectable graphical element option and/or a related marker indicator in accordance with one or more embodiments of the present disclosure.

FIG. 8 is a flowchart showing an example of a process for providing interactive user interface visualizations related to multi-channel search for complex domains in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout. Moreover, while certain embodiments of the present disclosure are described with reference to predictive data analysis, one of ordinary skills in the art will recognize that the disclosed concepts may be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like). A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

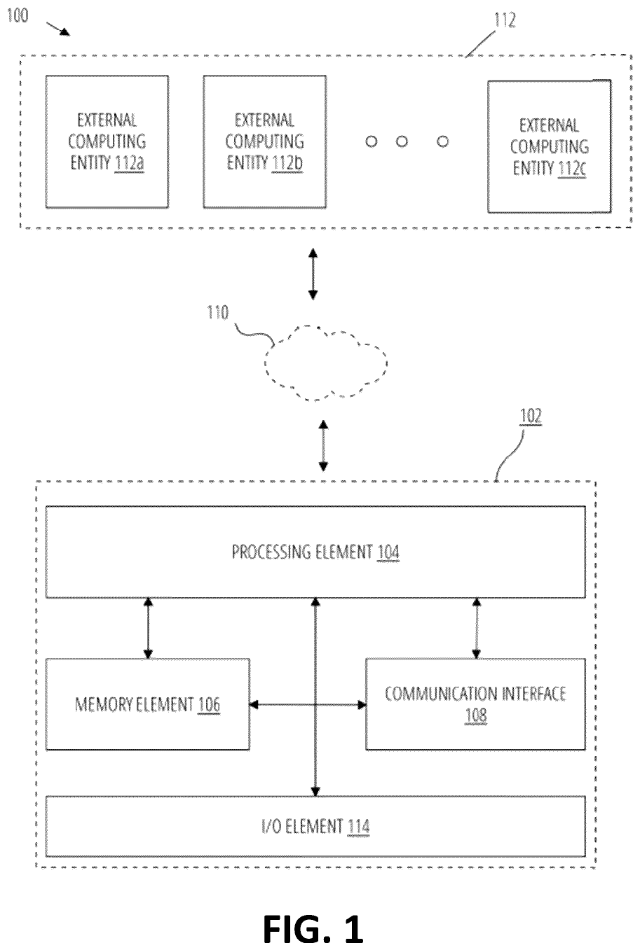

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., multi-modal matching techniques, query resolution techniques, and/or the like) described herein.

The external computing entities 112a-c, for example, may include and/or be associated with one or more entities that may be configured to receive, store, manage, and/or facilitate datasets, such as the domain knowledge datastore, and/or the like. The external computing entities 112a-c may provide such datasets, and/or the like to the predictive computing entity 102 which may leverage the datasets to evaluate a search query. In some examples, the datasets may include an aggregation of data from across the external computing entities 112a-c into one or more aggregated datasets. The external computing entities 112a-c, for example, may be associated with one or more data repositories, cloud platforms, compute nodes, organizations, and/or the like, that may be individually and/or collectively leveraged by the predictive computing entity 102 to obtain and aggregate data for a search domain.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

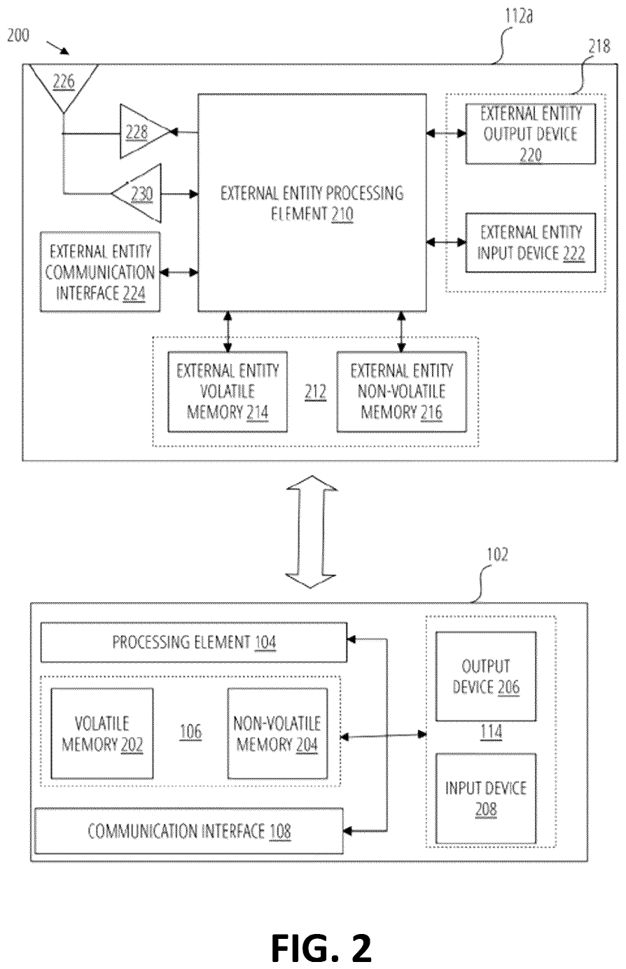

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product which includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, an electronic interface, a graphical user interface (GUI), a speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “user interface request” refers to a data signal that includes one or more data items or elements associated with a user interface that are collected, combined, and/or represented as part of the user interface request. In some examples, the user interface request may be generated and/or provided by a user interface of a user device. For instance, the user interface request may be generated by a user device via one or more computer program instructions executed by one or more processors of the user device. In some examples, the user interface request initiates one or more actions via a search engine to generate and/or return one or more graphical elements for the user interface. The user interface request may be transmitted via a network, an application programming interface (API), a communication channel, a communication interface, the like, or combinations thereof.

In some embodiments, the term “character-level text input” refers to a structured and/or natural language sequence of text (e.g., one or more alphanumeric characters, symbols, etc.). In some examples, the character-level text input may include user input, such as text input and/or text generated from one or more audio, tactile, and/or like inputs. In some examples, the character-level text input may include a natural language sequence of text. In some examples, the character-level text input may be provided via the user interface and/or a microphone of the user device. In some examples, the character-level text input is related to a search query.

In some embodiments, the term “search query” refers to a data entity that describes a text-based search query for a search domain. A search query, for example, may include a structured and/or natural language sequence of text (e.g., one or more alphanumeric characters, symbols, etc.). In some examples, the search query may include (i) a natural language sequence of text that expresses a question, preference, and/or the like and/or (ii) one or more contextual query attributes for constraining a result for the natural language sequence of text. In some examples, a search query for a clinical domain may include a natural language sequence of text to express a description of a medical condition and/or contextual query attributes, such as a location, member network, and/or the like that may constrain a recommendation for addressing the medical condition for a user. In some examples, a search query for a particular search domain may include one or more characteristics. As some examples, a search query may include a full word (e.g., “pediatrics” in a clinical domain) or a partial word (e.g., “pedia”) text. In addition, or alternatively, the search queries may correspond to one or more different topics within a search domain, such as (i) clinical conditions (e.g., adhd, etc.), (ii) clinical specialties (e.g., urgent care, etc.), and (iii) clinical services (eye exam, etc.) in a clinical domain. In some examples, a search query may be constrained by factors that correspond to the particular search domain, such as network plans, languages spoken by healthcare providers, a user's ability to travel for treatment, among other examples for a clinical domain. By way of example, keeping with the clinical example, a user may consider traveling 100 miles to have a foot surgery but would not want their primary care provider to be more than 5 miles from their location.

In some embodiments, a search query is input to and/or processed by a search engine. For example, a user may be allowed to type in full words (e.g., “pediatrics gastroenterology” in a clinical domain), partial words (e.g., “joh”) that may be autocompleted as best matched word(s) (e.g., “john”, “johnathan”), and/or the like into a search interface of the search engine. In response to the search query, the search engine may generate a plurality of comprehensive search results. For instance, using some of the techniques of the present disclosure, one or more multi-modal search functions may be applied to the search query (e.g., keyword search on provider profiles (e.g., names, addresses, IDs, etc.), topic search, etc.) to extract semantic and contextual information from the search query and intelligently match the search query with comprehensive query result data objects.

In some embodiments, the term “filter metadata” refers to one or more data items or elements that may be utilized to filter query result data objects related to a user interface request. In some examples, the filter metadata may include one or more contextual query attributes such as, for example, a location attribute (e.g., a GPS position, a latitude/longitude, etc.), one or more structured filters (e.g., selected categories, etc.), one or more user requested filters, and/or the like.

In some embodiments, the term “user identifier” refers to a data entity that identifies a user associated with a user interface request. In some examples, a user identifier may be included in a user interface request. For example, a header portion, a data segment portion, metadata, or another portion of a user interface request may include a user identifier. Alternatively, a user identifier may be determined using information included in a user interface request and/or the user device associated with the user interface request. For example, user device information, network address information, and/or other information included in a header portion, a data segment portion, metadata, or another portion of a search query may be correlated to a user identifier.

In some embodiments, the term “query result data object” refers to a data entity that describes a potential search result for a user interface request. A query result data object, for example, may be indicative (e.g., include an entity identifier, textual description, etc.) of an entity that is associated with one or more source features from a domain knowledge datastore. By way of example, a query result data object may include a domain knowledge profile for an entity that includes a plurality of source features corresponding to the entity. The entity may depend on the search domain. As one example, in a clinical domain, an entity may be a healthcare provider (e.g., facility, practitioner, medical group, etc.).

In some embodiments, the term “domain knowledge profile” refers to a data entity that describes a particular domain and/or entity. The domain knowledge profile may include a plurality of features corresponding to the particular domain and/or entity. In some examples, the domain knowledge profile may include a provider profile identifying a plurality of source features corresponding to the healthcare provider. In some examples, the plurality of source features for a particular query result data object may be distributed across a plurality of different information channels. Each of the source features may include one or more searchable attributes, such as source text attributes that may be searched using keyword matching techniques, source embedding attributes that may be searched using embedding matching techniques, and/or the like. In some examples, the plurality of source features for a query result data object may be divided into one or more different channels tailored to each of the sub-domains of the search domain to enable a multi-modal searching across multiple different topics expressed by a particular search domain.

In some embodiments, the term “domain knowledge datastore” refers to a dataset for a search domain. For example, a domain knowledge datastore may include a comprehensive dataset that aggregates data from a plurality of disparate data sources associated with a search domain. In some examples, the aggregated data may be stored in one or more different verticals to enable targeted retrieval and ingestion operations for accessing data. For example, the domain knowledge datastore may include source data that is associated with a plurality of different sub-domains within a search domain. In some examples, the source data may be ingested by a search engine through one or more different channels tailored to each of the sub-domains. In some embodiments, the search domain is associated with a plurality of potential query results. The potential query results may be represented within the domain knowledge datastore as query result data objects. The query result data objects may include a plurality of source features that describe one or more characteristics of the query result data objects.

In some embodiments, the domain knowledge datastore includes different sets of data for different search domains. For example, in a clinical domain, a domain knowledge datastore may include a plurality of query result data objects that correspond to one or more healthcare profiles for one or more healthcare providers within one or more different healthcare networks. For examples, the domain knowledge datastore may augment institution provider profiles with clinical knowledge, machine learning techniques, and/or the like, such that each source feature of a healthcare provider profile is searchable using natural language.

In some embodiments, the domain knowledge datastore includes one or more models, such as the language model, a machine learning embedding model, and/or the like. The machine learning embedding model, for example, may be leveraged to generate a plurality of source embedding attributes to augment the features of the domain knowledge datastore. In some examples, the models may be accessible (e.g., through machine learning service application programming interfaces (APIs), etc.) to process a search query as described herein.

In some examples, the domain knowledge datastore may include, for a clinical domain, a plurality of institutional provider profiles, including provider names, addresses, healthcare provider taxonomy codes (e.g., “207KA0200X”), network IDs, geocode (latitude/longitude), and/or miscellaneous information such as provider spoken languages, and/or the like. In addition, or alternatively, the domain knowledge datastore may include medical claim data including medical codes, such as ICD codes, current procedural terminology (CPT) codes, and/or the like, submitted by a provider in the last N months (default N=12). In addition, or alternatively, the domain knowledge datastore may include public clinical knowledge resources, such as text descriptions of taxonomies, ICD, and CPT codes, and/or the like. For example, one description for the taxonomy code “207KA0200X” may be “a physician who specializes in the diagnosis, treatment, and management of allergies.” In addition, or alternatively, the domain knowledge datastore may include one or more lists of manually crafted keywords/phrases clinically associated with each taxonomy code. For example, one key phrase related to “207KA0200X” may be “skin rash”, which is a common symptom of allergy. In addition, or alternatively, the domain knowledge datastore may include a sentence-transformer based health informatics text-embedding model fine-tuned to extract semantic and context information from, and transform a text sequence (e.g., a taxonomy description) into a D-dimension (default D=384) numeric vector. In addition, or alternatively, the domain knowledge datastore may include an LLM, such as the language model, that serves as a “library of knowledge” for interpreting queries. In addition, or alternatively, the domain knowledge datastore may include one or more enhanced taxonomies that correlated one or more disparate sets of data, such as correlating ICD codes with CPT codes, and/or the like.

In some embodiments, the term “language model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A language model may include one or more machine learning models configured, trained (e.g., jointly, separately, etc.), and/or the like to generate contextual information for a search query. A language model may include one or more of any type of machine learning model including one or more supervised, unsupervised, semi-supervised, reinforcement learning models, and/or the like. In some examples, a language model may include multiple models configured to perform one or more different stages of a generative language process.

In some embodiments, a language model is a generative machine learning model, such as a large language model (LLM). For example, a language model may include an LLM configured to generate contextual information for a search query that is grounded by a particular search domain. By way of example, the LLM may be trained using text data, such as source text attributes, for a search domain. The text data, for example, may be aggregated by a domain knowledge datastore configured for a search domain.

In some embodiments, the term “machine learning embedding model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning embedding model may include one or more machine learning models configured, trained (e.g., jointly, separately, etc.), and/or the like to encode textual data into one or more embeddings. A machine learning embedding model may include one or more of any type of machine learning model including one or more supervised, unsupervised, semi-supervised, reinforcement learning models, and/or the like. In some examples, a machine learning embedding model may include multiple models configured to perform one or more different stages of an embedding process.

In some embodiments, a machine learning embedding model is trained using one or more supervised training techniques. In some examples, a machine learning embedding model may be trained to factorize one or more inputs, such as one or more text strings, to generate an embedded vector. In some examples, a machine learning embedding model may be trained such that the model's latent space is representative of certain semantic domains/contexts, such as a clinical domain. For example, a machine learning embedding model may be trained to generate embeddings representative of one or more learned (and/or prescribed, etc.) relationships between one or more words, phrases, and/or sentences. By way of example, a machine learning embedding model may represent a semantic meaning of a word and/or sentence differently in relation to other words and/or sentences, and/or the like. The machine learning embedding model may include any type of embedding model finetuned on information for a particular search domain. By way of example, a machine learning embedding model may include one or more of SBERT, ClinicalBERT, BERT, Word2 Vec, GloVe, Doc2Vec, InferSent, Universal Sentence Encoder, and/or the like. A machine learning embedding model may be finetuned on the domain knowledge datastore, a plurality of historical search queries, and/or the like.

In some embodiments, the term “set of filtered query result data objects” refers to a set of query result data objects that are filtered based on filter metadata. For example, one or more query result data objects may be removed and/or modified from the set of query result data objects using the filter metadata.

In some embodiments, the term “selectable graphical element option” refers to a formatted version of one or more filtered query result data objects to provide a visualization and/or human interpretation of data associated with the one or more filtered query result data objects via a user interface. In some embodiments, a selectable graphical element option may additionally or alternatively be formatted for transmission via a network, an API, a communication channel, a communication interface, the like, or combinations thereof. In one or more embodiments, a selectable graphical element option may include one or more graphical elements and/or one or more textual elements that may be selectable and/or otherwise interacted with via a user interface.

In some embodiments, the term “map visualization” refers to a visual representation of a map to provide human interpretation and/or human interaction of the data via a user interface. In some embodiments, the map visualization is a real-time map visualization related to a search query. In some embodiments, a map visualization includes a map representation of a geographical region with graphics, textual information, satellite imagery, terrain details, roadway details, map details, and/or other information. In some embodiments, a map visualization may initiate a navigation route related to one or more selectable graphical element options. In some embodiments, a map visualization may provide a rendering of visual data indicative (e.g., representing, including a time and/or distance identifier, etc.) of a distance and/or time between a real-time location of a user device and a map location associated with a respective selectable graphical element option. In some embodiments, a visual scale of a map visualization may be dynamically configured in real-time based on interactions and/or visual renderings with respect to selectable graphical element options.

In some embodiments, the term “user location data” refers to a location information (e.g., a GPS position, a latitude/longitude, an address, a geofence location, etc.) associated with a user device and/or a user identifier. In some examples, the user location data may be based on a location module of the user device. The location module may be adapted to acquire, for example, latitude, longitude, altitude, geocode, course, direction, heading, speed, UTC, date, and/or various other information/data. In one embodiment, the location module may acquire data, such as ephemeris data, by identifying the number of satellites in view and the relative positions of those satellites (e.g., using GPS). The satellites may be a variety of different satellites, including LEO satellite systems, DOD satellite systems, the European Union Galileo positioning systems, the Chinese Compass navigation systems, Indian Regional Navigational satellite systems, and/or the like. This data may be collected using a variety of coordinate systems, such as the DD; DMS; UTM; UPS coordinate systems; and/or the like. Alternatively, the location information/data may be determined by triangulating a position of the user device in connection with a variety of other systems, including cellular towers, Wi-Fi access points, and/or the like. In some embodiments, the location module may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, BLE transmitters, NFC transmitters, and/or the like.

In some examples, the user location data may be additionally or alternatively based on location text input provided via the user interface. For example, the location text input may be a sequence of text such as text input and/or text generated from one or more audio, tactile, and/or like inputs. In some examples, the location text input may correspond to an address associated with the user device.

In some embodiments, the term “user requested filter” refers to one or more data items or elements associated with a filter option selected by a user via a user interface. In some examples, a filter option may be related to a type of data source, search domain parameters, user preferences, location preferences, entity preferences (e.g., provider specialty, etc.), and/or another type of filter option. In some examples, a user requested filter may be selected via a selectable graphical element via a user interface.

### IV. Overview

Embodiments of the present disclosure presents interactive map-based visualization techniques related to multi-channel search for complex domains that improve computer interpretation and visualization through various data and query processing operations. In various embodiments, the interactive map-based visualization techniques may be provided in combination with multi-model, multi-channel, and/or multi-stage query resolution techniques. Traditional approaches for resolving queries rely on either keyword searching or semantic matching each of which are subject to several downsides as described herein. Unlike traditional approaches, some embodiments of the present disclosure enable the intelligent combination of both semantic and syntactic insights to provide a real-time map visualization for a search query and related searchable results. For example, using some of the techniques of the present disclosure, user experiences related to search queries via web pages, mobile applications, and/or other user interfaces may be improved. In some examples, the interactive map-based visualization techniques disclosed herein provide enhanced search time and/or location presentations via user interfaces using a combination of a search engine (e.g., a billion-scale vector search engine) and real-time map visualizations.

In various embodiments, the search engine may generate and/or aggregate a plurality of embedding similarity scores and keyword similarity scores for a search query to create aggregated similarity scores for a plurality of searchable features. These features may then be leveraged, through a multi-stage query resolution process, to generate a query resolution for a search query that is explainable, comprehensive, and tailored to the user's predicted intent behind the query. By doing so, some of the techniques of the present disclosure present an end-to-end technical solution for searching within complex, multi-faceted search domains that is adaptable to organizational web pages, mobile applications, or any other searching medium. In this respect, the computer interpretation techniques of the present disclosure may be practically applied to improve the performance of traditional query engines in any search domain. Moreover, the computer interpretation techniques of the present disclosure may be practically applied to improve the performance of user interfaces of user devices by optimizing the presentation of graphical elements for a display screen and/or by minimizing the number of user interactions with the display screen, thereby reducing the number of computing resources utilized by the user device for providing a real-time map visualization for a search query and related searchable results.

In some embodiments of the present disclosure, the computer interpretation techniques may be applied through a query resolution process for providing search results via a user interface by receiving a real-time user interface request that includes character-level text input, matching the character-level text input with domain knowledge profiles, filtering the matched domain knowledge profiles based on user location and/or user requested filters to provide search results, and/or presenting the search results via selectable graphical element options correlated to a real-time map visualization. The character-level text input may allow dynamically configured presentation of the selectable graphical element options and/or data for the real-time map visualization such that, by updating the user interface visualizations in response to individual character level inputs, the techniques of the present disclosure provide improved search techniques that may interactively augment and display results as the user provides a search query. Accordingly, a search query may be dynamically updated based on data continuously output in a visually comprehensive manner to the user. In this manner, some of the techniques of the present disclosure may be practically applied in any search domain to improve user interfaces for a variety of search engines.

In doing so, various embodiments of the present disclosure address shortcomings of existing traditional searching techniques and/or user experiences related therewith by providing solutions that are capable of efficient and reliable processing of search queries while also providing efficient and reliable map-based visualizations related to search query results. For example, using some of the techniques of the present disclosure, search queries initiated via a user interface may be resolved in a shorter amount of time and/or by utilizing fewer computing resources as compared to traditional searching techniques. Additionally, or alternatively, map-based visualizations related to the search queries may be rendered in a shorter amount of time and/or by utilizing fewer computing resources as compared to traditional user experiences for traditional user interfaces. Example inventive and technologically advantageous embodiments of the present disclosure additionally include improved data analytics, data processing, and/or machine learning with respect to data related to search queries. Example inventive and technologically advantageous embodiments of the present disclosure additionally include improved quality and/or accuracy of search query results related to search queries.

Moreover, examples of technologically advantageous embodiments of the present disclosure include: (i) a domain knowledge datastore, including the manually crafted keywords/phrases clinically associated with specialties and a fine-tuned text embedding model that transforms a text sequence related to a search query into embedding vectors, (ii) multi-stage searching techniques that match search queries with provider service experience characterized by healthcare provider taxonomies, ICDs, CPTs, and/or the like, (iii) a hybrid approach that combines keyword/typeahead searching for search queries with text embedding techniques to generate aggregated similarity insights, (iv) a federated API that leverages a multi-channel, multi-stage searching strategy to deliver a comprehensive response to a search query efficiently, (v) LLMs to interpret and expand search queries, and/or (vi) real-time map visualizations optimized for presenting search query results, among other aspects of the present disclosure. Other technical improvements and advantages may be realized by one of ordinary skill in the art.

### V. Example System Operations

As indicated, various embodiments of the present disclosure make important technical contributions to query resolution technology and/or user interface technology. In particular, systems and methods are disclosed herein that implement a multi-modal and multi-channel search resolution techniques to improve query comprehension and generate holistic query resolutions for a user interface. Unlike traditional query resolution techniques, some of the techniques of the present disclosure combine semantic and syntactic similarity scores across a plurality of channels of information aggregated by a domain knowledge datastore. By doing so, search results may be generated that capture the underlying intent behind search queries in complex search domains. Meanwhile, by providing multi-channel information in response to a search, the techniques of the present disclosure may improve both the accuracy and interpretability of query resolutions while also optimizing one or more renderings of the query resolutions via a user interface.

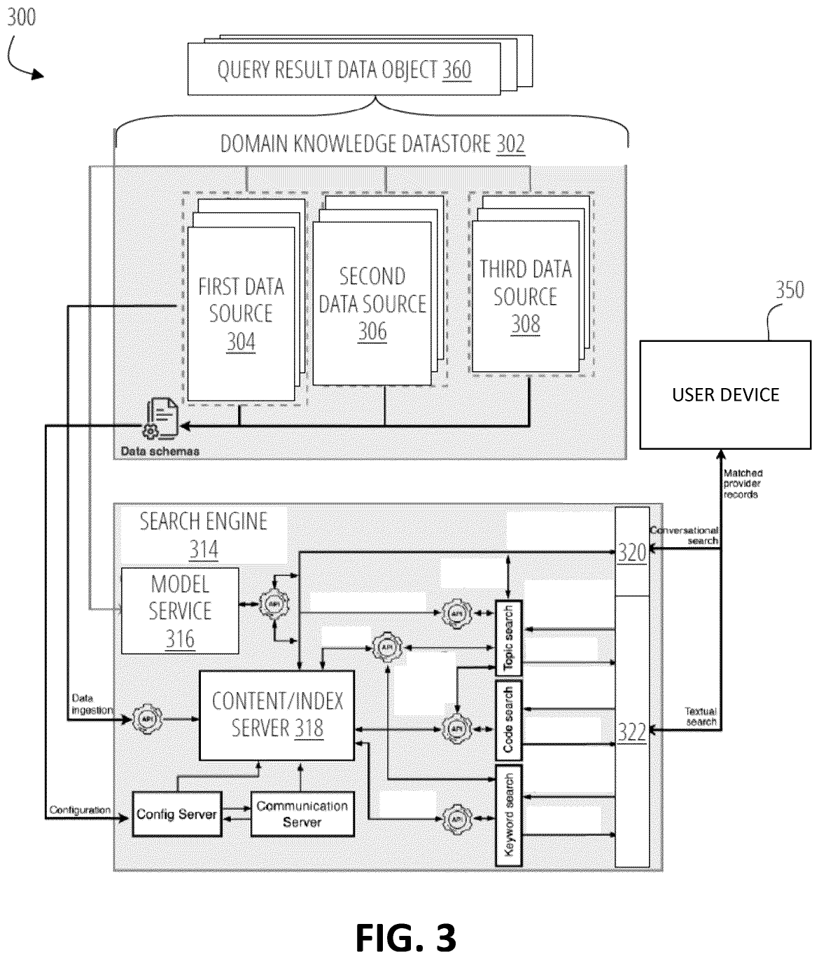

FIG. 3 is a system diagram 300 showing an example query resolution system in accordance with some embodiments discussed herein. The system diagram 300 depicts a computing system, such as the computing system 100 described herein, that includes one or more communicatively connected computing entities including, for example, a domain knowledge datastore 302 and/or a search engine 314. In some examples, the domain knowledge datastore 302 and/or search engine 314 may independently and/or jointly receive a search query from a user and, in response to the search query, provide a comprehensive query resolution. By way of example, the search engine 314 may be configured to receive, via one or more interface APIs (e.g., conversational API, federated API, etc.), a search query from a user. The search engine 314 may leverage one or more multi-modal search techniques of the present disclosure to generate a comprehensive query resolution for the search query based on multi-channel information ingested from the domain knowledge datastore 302.

In some embodiments, the domain knowledge datastore 302 includes a computing entity that is configured to aggregate data for a search domain from a plurality of disparate data source, by way of example, the domain knowledge datastore 302 may include data from a first data source 304, a second data source 306, and third data source 308, and/or any number of addition data sources. The data sources may depend on the search domain. For example, the domain knowledge datastore 302 may be tailored to a search domain and may aggregate data from one or more data sources for the search domain. By of example, in a clinical domain, the data sources may be clinical in nature and may include, as examples, (i) a first data source 304 of clinical knowledge, such as clinical taxonomy descriptions, specialty keywords, code descriptions (e.g., ICD, ICPT code descriptions, etc.), and/or the like, (ii) a second data source 306 of medical claims information, such as medical codes (e.g., ICD, CPT codes, etc.), provider identifiers, service locations, and/or the like from historical medical claims, (iii) a third data source 308 of provider information, such as practitioner taxonomy codes, provider specialties, provider identifiers, provider address, and/or the like, among other clinically relevant data sources.

In some embodiments, the domain knowledge datastore 302 includes a comprehensive dataset for a search domain. For example, the domain knowledge datastore 302 may include a comprehensive dataset that aggregates data from a plurality of disparate data sources associated with the search domain. In some examples, the aggregated data may be stored in one or more different verticals to enable targeted retrieval and ingestion operations for accessing data. For example, the domain knowledge datastore 302 may include source data that is associated with a plurality of different sub-domains within the search domain. In some examples, the source data may be ingested by the search engine 314 through one or more different channels tailored to each of the sub-domains.

In some embodiment, the search domain is associated with a plurality of potential query results. The potential query results may be represented within the domain knowledge datastore 302 as query result data objects 360. The query result data objects 360 may include a plurality of source features that describe one or more characteristics of the query result data objects 360. The source features, for example, may be aggregated for each of the query result data objects 360 from a plurality of different data sources, such as the first data source 304, the second data source 306, the third data source 308, and/or the like. Each of the source features may include one or more searchable attributes, such as source text attributes that may be searched using keyword matching techniques, source embedding attributes that may be searched using embedding matching techniques, and/or the like. In some examples, the plurality of source features for the query result data objects 360 may be divided into one or more different channels tailored to each of the sub-domains of the search domain to enable a multi-modal searching across multiple different topics expressed by a particular search domain.

In some embodiments, the domain knowledge datastore 302 includes different sets of data for different search domains. For example, in a clinical domain, a domain knowledge datastore 302 may include a plurality of query result data objects 360 that correspond to one or more healthcare profiles for one or more healthcare providers within one or more different healthcare networks. For examples, the domain knowledge datastore 302 may augment institution provider profiles with clinical knowledge, machine learning techniques, and/or the like, such that each source feature of a healthcare provider profile is searchable using natural language and/or embeddings thereof. In some examples, the augmented data may be ingested as channels within the search engine 314.

In some embodiments, the domain knowledge datastore 302 includes one or more models, such as a language model, a machine learning embedding model, and/or the like. In some examples, the models may be leveraged by the domain knowledge datastore 302 to augment source features for the query result data objects 360. For instance, a machine learning embedding model may be leveraged to generate a plurality of source embedding attributes to augment the features of the domain knowledge datastore 302. In some examples, the models (e.g., language models, embedding models, etc.) may be accessible (e.g., through machine learning service APIs, etc.) to process a search query. By way of example, the search engine 314 may include a model service 316 configured to access the one or more models of the domain knowledge datastore 302.

In some examples, the domain knowledge datastore 302 may include, for a clinical domain, a plurality of institutional provider profiles, including provider names, addresses, healthcare provider taxonomy codes (e.g., “207KA0200X”), network IDs, geocode (latitude/longitude), and/or miscellaneous information such as provider spoken languages, and/or the like. The plurality of institutional provider profiles, for example, may include provider data received from one or more third data sources 308. In addition, or alternatively, the domain knowledge datastore 302 may include medical claim data including medical codes, such as ICD codes, CPT codes, and/or the like, submitted by a provider in the last N months (default N=12). The medical claim data, for example, may be extracted and/or received from one or more second data sources 306 (e.g., claim processors, etc.) configured receive, process, and/or store medical claims. In addition, or alternatively, the domain knowledge datastore 302 may include public clinical knowledge resources, such as text descriptions of taxonomies, ICD, and CPT codes, and/or the like. For example, one description for the taxonomy code “207KA0200X” may be “a physician who specializes in the diagnosis, treatment, and management of allergies.” In addition, or alternatively, the domain knowledge datastore 302 may include one or more lists of manually crafted keywords/phrases clinically associated with each taxonomy code. For example, one key phrase related to “207KA0200X” may be “skin rash”, which is a common symptom of allergy. The clinical knowledge, for example, may be extracted and/or received from one or more first data sources 304.

In some examples, the domain knowledge datastore 302 may include a sentence-transformer based health informatics text-embedding model fine-tuned to extract semantic and context information from, and transform a text sequence (e.g., a taxonomy description) into a D-dimension (default D=384) numeric vector. For example, the domain knowledge datastore 302 may include a machine learning embedding model.

In some embodiments, the machine learning embedding model is a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning embedding model may include one or more machine learning models configured, trained (e.g., jointly, separately, etc.), and/or the like to encode textual data into one or more embeddings. A machine learning embedding model may include one or more of any type of machine learning model including one or more supervised, unsupervised, semi-supervised, reinforcement learning models, and/or the like. In some examples, a machine learning embedding model may include multiple models configured to perform one or more different stages of an embedding process.

In some embodiments, a machine learning embedding model is trained using one or more supervised training techniques. In some examples, a machine learning embedding model may be trained to factorize one or more inputs, such as one or more text strings, to generate an embedded vector. In some examples, a machine learning embedding model may be trained such that the model's latent space is representative of certain semantic domains/contexts, such as a clinical domain. For example, a machine learning embedding model may be trained to generate embeddings representative of one or more learned (and/or prescribed, etc.) relationships between one or more words, phrases, and/or sentences. By way of example, a machine learning embedding model may represent a semantic meaning of a word and/or sentence differently in relation to other words and/or sentences, and/or the like. The machine learning embedding model may include any type of embedding model finetuned on information for a particular search domain. By way of example, a machine learning embedding model may include one or more of SBERT, ClinicalBERT, BERT, Word2Vec, GloVe, Doc2Vec, InferSent, Universal Sentence Encoder, and/or the like. A machine learning embedding model may be finetuned on the domain knowledge datastore 302, a plurality of historical search queries from the search engine 314, and/or the like.

In some examples, the domain knowledge datastore 302 may include an LLM that serves as a “library of knowledge” for interpreting queries. For example, the domain knowledge datastore 302 may include a language model.

In some embodiments, the language model is data entity that describes parameters, hyper-parameters, and/or defined operations of a rules-based and/or machine learning model (e.g., model including at least one of one or more rule-based layers, one or more layers that depend on trained parameters, coefficients, and/or the like). A language model may include one or more machine learning models configured, trained (e.g., jointly, separately, etc.), and/or the like to generate contextual information for a search query. A language model may include one or more of any type of machine learning model including one or more supervised, unsupervised, semi-supervised, reinforcement learning models, and/or the like. In some examples, a language model may include multiple models configured to perform one or more different stages of a generative language process.

In some embodiments, a language model is a generative machine learning model, such as an LLM. For example, a language model may include an LLM configured to generate contextual information for a search query that is grounded by a particular search domain. By way of example, the LLM may be trained using text data, such as source text attributes, for a search domain. The text data, for example, may be aggregated by the domain knowledge datastore 302 configured for a search domain.

In addition, or alternatively, the domain knowledge datastore may include one or more enhanced taxonomies that correlate one or more disparate sets of data, such as correlating ICD codes with CPT codes, and/or the like. For example, the domain knowledge datastore 302 may include an enhanced taxonomy.

In some embodiments, the enhanced taxonomy is a taxonomy dataset that is augmented with a plurality of augmented taxonomy categories. Augmented taxonomy categories, for example, may include a taxonomy category that is augmented with at least a portion of a textual description corresponding to an associated code. In some examples, an augmented taxonomy category may be generated by mapping, associating with, appending, and/or the like a textual description (at least a portion thereof) to a taxonomy category. In this manner, the taxonomy dataset may be augmented to generate an enhanced taxonomy with a plurality of augmented taxonomy categories. By increasing the contextual information for the taxonomy categories of various taxonomy datasets, the enhanced taxonomy may be leveraged to make more relevant and targeted connections between a search query and a plurality of potential search results. This, in turn, may enable more accuracy query resolutions, while preventing null results that are predominant in traditional query resolution techniques.

The domain knowledge datastore 302 may be communicatively connected to the search engine 314, which may be configured to receive a search query and leverage the domain knowledge datastore 302 to generate a query resolution for the search query. By way of example, the search engine 314 may include a billion-scale vector search engine that may be backward compatible to support traditional and/or advanced search functions. For instance, the search engine 314 may include a plurality of internal and external application programming interfaces collectively configured to facilitate a multi-modal search query resolution.

In some embodiments, the search engine 314 includes a plurality of search interfaces configured to interact with a plurality of user devices 350. The search interfaces may include a conversational search interface 320, a textual search interface 322, and/or the like. The textual search interface 322 may include a federated API that is configured to initiate one or more different search routines based on a search query input by a user (e.g., a user identifier) associated with a user device 350. For example, the different search routines may include a keyword search, a code search, and/or a topic search.

In some examples, a keyword search routine may receive a search query (and/or portions thereof), such as a name/address, one or more geo-structured filters, and/or the like, and initiate one or more computing tasks, such as typeahead/term query tasks, spelling correction tasks, and/or the like, based on the search query. In some examples, the keyword search routine may generate one or more similarity scores for a plurality of source features using one or more techniques of the present disclosure. In some examples, the keyword search routine may return one or more matched query result data objects to the textual search interface 322 for providing a query resolution to the user device 350.

In some examples, a code search routine may receive a search query (and/or portions thereof), such as one or more alphanumeric codes (e.g., ICD codes, CPT codes, etc.), and/or the like, and initiate one or more computing tasks based on the search query. In some examples, the code search routine may generate one or more similarity scores for a plurality of source features using one or more techniques of the present disclosure. In some examples, the code search routine may return one or more matched query result data objects to the textual search interface 322 for providing a query resolution to the user device 350.

In some examples, a topic search routine may receive a search query (and/or portions thereof), such as one or more generic text references (e.g., service topics, etc.), and/or the like, and initiate one or more computing tasks, such as typeahead/term query tasks, spelling correction tasks, and/or the like, based on the search query (and/or portions thereof). In some examples, the topic search routine may generate one or more similarity scores for a plurality of source features using one or more techniques of the present disclosure. By way of example, the one or more similarity scores may include one or more aggregated similarity scores that aggregate keyword and embedding similarities across a plurality of source features. In some examples, the topic search routine may return one or more matched query result data objects to the textual search interface 322 for providing a query resolution to the user device 350.

In some examples, the topic search routine may be configured to generate, using the language model, an expanded query for the search query to enhance a query resolution for a user. In some examples, the same and/or similar techniques may be leveraged by the conversational search interface 320 to provide contextual data to the user device 350 based on an intermediate search query. For instance, the topic search routine may generate an expanded query and leverage the expanded query to generate a query resolution for a search query. The conversational search interface 320 may generate an expanded query and provide the expanded query to the user device 350. The user device 350 may leverage the expanded query as a new search query to textual search interface 322.

In some embodiments, the expanded query is a data entity that describes a search query that is augmented with contextual information for a search domain. An expanded query, for example, may include a structured and/or natural language sequence of text. In some examples, the expanded query may be generated from a search query using a language model. For example, a language model may be applied to the search query to interpret the search query and generate contextual information to augment the natural language sequence of text of the search query. In some examples, as described herein, a language model may be trained using a text data for a particular search domain to generate contextual information that is relevant for the search domain. For instance, in a clinical domain, a search query for a term “sickle cell,” which may be a rare genetic disorder in blood cells, may be expanded to “sickle cell disease is a genetic disorder that affects the red blood cells” to provide semantic and syntactic information to improve the similarity between the search query and one or more intermediate or final search results for the search query. By way of example, the added phrases “genetic disorder,” “red blood cells,” and/or the like may improve similarities with proper specialties, such as a “hematologist” that may treat the originally provided search query, “sickle cell.”

In some embodiments, the search engine 314 facilitates the computing tasks for each of the search routines through communications with the domain knowledge datastore 302. For instance, the search engine 314 may include a model service 316 for accessing one or more models (e.g., through one or more model backends, etc.) of the domain knowledge datastore 302. The one or more models, for example, may be accessed to generate embedding representations for a search query (e.g., using a machine learning embedding model, etc.), generate expanded queries (e.g., using language model, etc.), and/or the like.

In addition, or alternatively, the search engine 314 may ingest a plurality of multi-channel information from the domain knowledge datastore 302. For example, the multi-channel information may be ingested by a content/index server 318. The multi-channel information may be configured, using a configuration server and/or communication server, in accordance with one or more data schemas of the domain knowledge datastore 302. In this manner, comprehensive data from a plurality of different data sources may be aggregated, pruned, and organized in a searchable manner by the domain knowledge datastore 302 and then ingested as multi-channel representations to the search engine 314 for processing a search query.

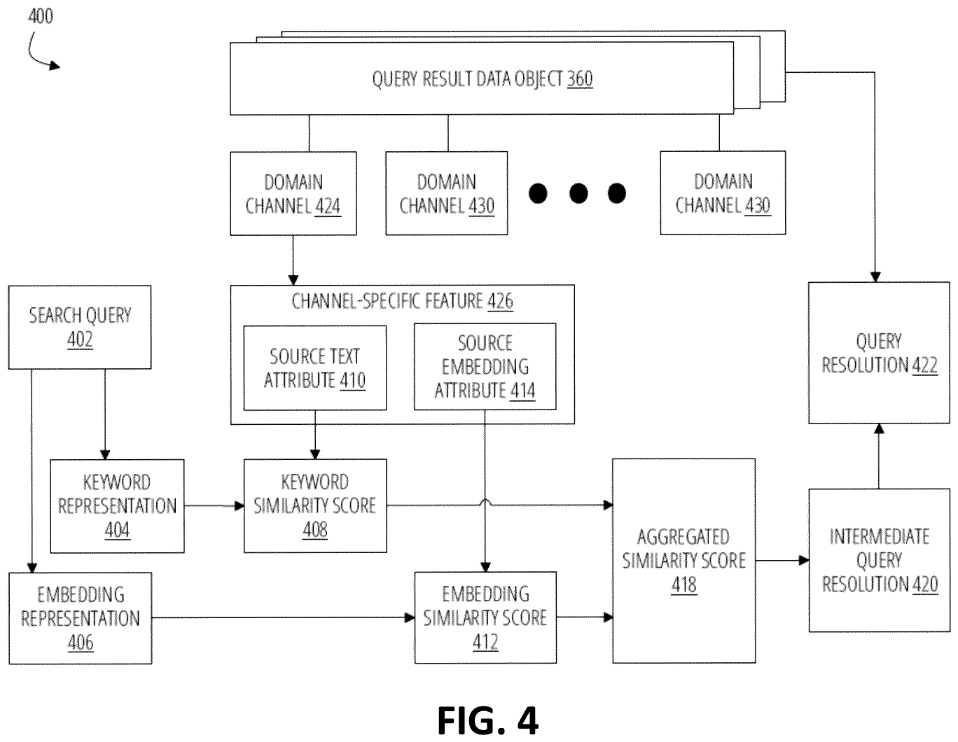

In some embodiments, the search engine 314 is configured to generate a query resolution for a search query using one or more multi-modal searching techniques. An example of a query resolution technique will now further be described with reference to FIG. 4.

FIG. 4 is a dataflow diagram 400 showing example data structures and modules for generating a query resolution in accordance with some embodiments discussed herein. The dataflow diagram 400 shows a multi-modal query resolution process for generating a query resolution from a search query 402. The search query 402 may be provided by the user device 350 or another external computing entity of the external computing entities 112a-c.

In some embodiments, the search query 402 may include a natural language text sequence and/or one or more contextual search attributes. In some embodiments, the search query 402 is a data entity that describes a text-based search query for a search domain. A search query 402, for example, may include a structured and/or natural language sequence of text (e.g., one or more alphanumeric characters, symbols, etc.). In some examples, the search query 402 may include user input, such as text input and/or text generated from one or more audio, tactile, and/or like inputs. In some examples, the search query 402 may include a natural language sequence of text. In some examples, the natural language sequence of text may be associated with one or more contextual query attributes. The contextual query attributes, for example, may include a location attribute (e.g., a global positioning system (GPS) position, a latitude/longitude, etc.), one or more structured filters (e.g., selected categories, etc.), and/or the like. In some examples, the search query 402 may include (i) a natural language sequence of text that expresses a question, preference, and/or the like and/or (ii) one or more contextual query attributes for constraining a result for the natural language sequence of text.

In some embodiments, the search query 402 is based on a search domain. For example, a search query 402 for a clinical domain may include a natural language sequence of text to express a description of a medical condition and/or contextual query attributes, such as a location, member network, and/or the like that may constrain a recommendation for addressing the medical condition for a user. In some examples, the search query 402 for a particular search domain may include one or more characteristics. As some examples, the search query 402 may include a full word (e.g., “pediatrics” in a clinical domain) or a partial word (e.g., “pedi”) text. In addition, or alternatively, the search queries 402 may correspond to one or more different topics within a search domain, such as (i) clinical conditions (e.g., adhd, etc.), (ii) clinical specialties (e.g., urgent care, etc.), and (iii) clinical services (eye exam, etc.) in a clinical domain. In some examples, the search query 402 may be constrained by factors that correspond to the particular search domain, such as network plans, languages spoken by healthcare providers, a user's ability to travel for treatment, among other examples for a clinical domain. By way of example, keeping with the clinical example, a user may consider traveling 100 miles to have a foot surgery but would not want their primary care provider to be more than 5 miles from their location.

In some embodiments, the search query 402 may be generated via a user interface of the user device 350. In some embodiments, the search query 402 may correspond to and/or otherwise be associated with a user interface request that includes character-level text input related to the search query, filter metadata for a user identifier associated with the user interface request, and/or other information to facilitate a query resolution process for the search query 402.

In some embodiments, the search query 402 is input to and/or processed by a search engine (e.g., the search engine 314), as described herein. For example, a user may be allowed to type in full words (e.g., “pediatrics gastroenterology” in a clinical domain), partial words (e.g., “joh”) that may be autocompleted as best matched word(s) (e.g., “john”, “johnathan”), and/or the like into a user interface of the user device 350 that is communicatively coupled to the search engine. In response to the search query 402, the search engine may generate a plurality of comprehensive search results. For instance, using some of the techniques of the present disclosure, one or more multi-modal search functions may be applied to the search query 402 (e.g., keyword search on provider profiles (e.g., names, addresses, IDs, etc.), topic search, etc.) to extract semantic and contextual information from the search query 402 and intelligently match the search query 402 with comprehensive query result data objects 360. In some examples, search/typeahead functions may be used in combination with structured filters (e.g., location, provider network) to accommodate user preferences.

In some embodiments, a keyword representation 404 and/or an embedding representation 406 are generated for the search query 402. The keyword representation 404, for example, may include one or more text units from the natural language text sequence of the search query 402. In addition, or alternatively, the embedding representation 406 may include a numerical vector for the natural language text sequence.

In some embodiments, the keyword representation 404 is a text-based representation of a search query 402. For example, the keyword representation 404 may include a plurality of text units from a textual sequence. The text units, for example, may include a plurality of keywords extracted (e.g., by a keyword extraction model, etc.) from the textual sequence. By way of example, the keyword representation 404 may include the plurality of extracted keywords.

In some embodiments, the embedding representation 406 is a vector-based representation of the search query 402. For example, the embedding representation 406 may include an embedded vector from a textual sequence associated with the search query. The embedding representation 406, for example, may include an embedding vector (e.g., numeric vector, etc.) that captures a search query's semantic and/or contextual meaning. By way of example, the embedding representation 406 may be generated by processing the search query 402 with a machine learning embedding model, such as the machine learning model described herein.

In some embodiments, an expanded query is generated for the search query 402. For example, the expanded query may be generated using a language model as described herein. The language model, for example, may be trained based on a plurality of source features (e.g., source text attributes thereof, etc.) from a domain channel. In some examples, the keyword representation 404 and/or the embedding representation 406 may be generated based on the expanded query.

In some embodiments, a plurality of similarity scores is generated for the search query 402 based on the keyword representation 404 and/or embedding representation 406. In some examples, each similarity score may be indicative (e.g., a measure representing, etc.), of a similarity between the search query 402 and a source feature associated with one or more query result data objects 428. For example, each similarity score may be generated based on a measure of similarity between a query representation (e.g., keyword representation 404, embedding representation 406, etc.) and a corresponding representation for a particular source feature within a dataset associated with a plurality of query result data objects 428.

In some examples, a query result data object 360 is a data entity that describes a potential search result for a search domain. The query result data object 360, for example, may be indicative (e.g., include an entity identifier, textual description, etc.) of an entity that is associated with one or more source features from the domain knowledge datastore. By way of example, the query result data object 360 may include a profile for an entity that includes a plurality of source features corresponding to the entity. The entity may depend on the search domain. As one example, in a clinical domain, an entity may be a healthcare provider (e.g., facility, practitioner, medical group, etc.) and the query result data object 360 may include a provider profile identifying a plurality of source features corresponding to the healthcare provider. In some examples, the plurality of source features for a particular query result data object 360 may be distributed across a plurality of different information channels.

In some examples, a source feature is a data entity that describes a characteristic corresponding to one or more potential search results of a search domain. A source feature, for example, may be indicative (e.g., include an attribute identifier, textual description, etc.) of an attribute that may be associated with one or more query result data objects 360. For instance, a source feature may include an object-specific source feature that corresponds to a single query result data object (e.g., a unique name, precise location, etc.). In addition, or alternatively, a source feature may include an object-generic source feature (e.g., a general location, a specialty, an activity frequency, etc.). In some examples, the object-generic source features (and/or the object-specific source features) may be based on a search domain. By way of example, a clinical domain may include a plurality of source features that describe one or more taxonomy codes (e.g., clinical specialties, etc.), assessment codes (e.g., ICD codes, etc.), intervention codes (e.g., CPT codes, etc.), and/or the like that may associated with one or more of the plurality of query result data objects 360 within a search domain.

In some examples, a source text attribute is an attribute of a source feature represented as one or more characters. For example, a source text attribute may include a numeric, alpha-numeric, and/or the like code (e.g., taxonomy code, ICD code, CPT code, etc.) that corresponds to a source feature. In addition, or alternatively, a source text attribute may include a textual description that corresponds to the source feature (e.g., a taxonomy description, code description, etc.).

In some examples, a source embedding attribute is an attribute of a source feature represented as a numerical vector. For example, a source embedding attribute may include an embedded representation of a source text attribute and/or contextual information for the source text attribute. In some examples, a source embedding attribute may be generated, using a machine learning embedding model, for one or more of the source features to complement a source text attribute in a multi-modal search environment.

In some embodiments, the similarity scores are generated for each of a plurality of source features from a multi-channel dataset. The multi-channel dataset, for example, may include a plurality of domain channels, such as the domain channel 424 and/or one or more other domain channels 430. The domain channel 424, for example, may be one of a plurality of domain channels (e.g., domain channel 424, other domain channels 430, etc.). In some examples, each of the domain channels, such as the domain channel 424, may include channel-specific features 426. By way of example, the domain channel 424 may include a first domain channel with a plurality of first channel features corresponding to a first topic type. In addition, or alternatively, the other domain channels 430 may include a second domain channel with a plurality of second channel features corresponding to a second topic type, a third domain channel with a plurality of third channel features corresponding to a third topic type, a fourth domain channel with a plurality of fourth channel features corresponding to a fourth topic type, a fifth domain channel with a plurality of fifth channel features corresponding to a fifth topic type, and/or the like.

In some embodiments, each of the plurality of domain channels (e.g., domain channel 424, other domain channels 430, etc.) include one or more respective channel-specific features for each of a plurality of query result data objects 428. In some examples, each of the channel-specific features 426 may include one or more source text attributes 410 and/or source embedding attributes 414. The plurality of similarity scores may be based on a plurality of source text attributes 410 and a plurality of source embedding attributes 414 that respectively correspond to a plurality of channel-specific features 426 within the domain channel 424. A plurality of additional similarity scores may be generated in the same and/or similar manner with respect to each of the other domain channels 430 within the multi-channel dataset to generate a plurality of multi-modal similarity scores across a plurality of different information channels.

In some embodiments, the domain channel 424 is a dataset of source features that correspond to a sub-domain within a search domain. For example, a complex search domain may be divided into a plurality of sub-domains, each representing different channels of information that may be collectively and/or individually queried to generate a query resolution 422 for a search query 402. Each of the plurality of sub-domains may be represented by a plurality of source features that correspond to a particular search topic within the complex search domain. According to some techniques of the present disclosure, a comprehensive search resolution may be generated by aggregating multi-channel search results across each of a plurality of domain channels corresponding to the respective sub-domains of the complex search domain. By way of example, some techniques of the present disclosure enable a single search query 402 to reach multiple verticals (e.g., sub-domains such as provider profiles, specialties, services, etc.) through a federated application programming interface (API) that submits queries to and aggregates matched results from each of the domain channels asynchronously. In this manner, a domain channel 424 may be leveraged as an efficient approach to group results from verticals and provide a comprehensive response to a search query 402.

In some embodiments, a number and type of domain channels depends on the search domain. For example, in a clinical search domain, source data from provider records may be represented with two, three, four, five, etc. channels of information. By way of example, a domain channel 424 may include five channels including a profile channel, an identifier channel, a taxonomy channel, an assessment channel, and intervention channel, and/or the like.

In some embodiments, the channel-specific feature 426 is a source feature of a domain channel 424. By way of example, a channel-specific feature 426 may include a profile feature for a profile channel, an identifier feature for an identifier channel, a taxonomy feature for a taxonomy channel, an assessment feature for an assessment channel, an intervention feature for an intervention channel, and/or the like.

In some embodiments, the profile channel is an example domain channel for a search domain. For example, in a clinical domain, a profile channel may include provider information such as a name, address, network identifiers, geo-location, and/or the like.

In some embodiments, the identifier channel is an example domain channel for a search domain. For example, in a clinical domain, an identifier channel may include provider-related IDs, such as national provider IDs, enterprise provider IDs, and/or the like.

In some embodiments, the taxonomy channel is an example domain channel for a search domain. For example, in a clinical domain, a taxonomy channel may include a plurality of taxonomy codes, textual descriptions, embedding vectors, and/or the like. In some examples, the taxonomy channel may capture a provider's specialty characteristics specified in the national practitioner data bank (NPDB).

In some embodiments, the assessment channel is an example domain channel for a search domain. For example, in a clinical domain, an assessment channel may include ICD codes, textual descriptions, embedding vectors of ICD descriptions, and/or the like. In some examples, the assessment channel may capture clinical conditions a provider has treated based the claim information.

In some embodiments, the intervention channel is an example domain channel for a search domain. For example, in a clinical domain, an intervention channel may include CPT codes, textual descriptions, embedding vectors of CPT descriptions, and/or the like. In some examples, the intervention channel captures clinical procedures a provider has performed based on the claim information.

In some embodiments, the plurality of similarity scores includes a plurality of keyword similarity scores 408. For example, a plurality of keyword similarity scores 408 may be generated between the keyword representation 404 and a plurality of source text attributes 410 from a domain channel 424.

In some embodiments, a keyword similarity score 408 is a text-based measure of similarity between the search query 402 and a source feature, such as the channel-specific feature 426. For example, the keyword similarity score 408 may include a numeric representation (e.g., a real number, probability, etc.) indicative (e.g., a measure representing, etc.) of a similarity between the search query 402 and the channel-specific feature 426. The keyword similarity score 408, for example, may include a syntactic similarity measure between the keyword representation 404 and a source text attribute 410 of a source feature, such as the channel-specific feature 426.

In some embodiments, the plurality of similarity scores includes a plurality of embedding similarity scores 412. For example, the plurality of embedding similarity scores 412 may be generated between the embedding representation 406 and a plurality of source embedding attribute 414s from the domain channel 424.

In some embodiments, an embedding similarity score 412 is an embedding-based measure of similarity between a search query 402 and a source feature. For example, an embedding similarity score 412 may include a numeric representation (e.g., a real number, probability, etc.) indicative (e.g., a measure representing, etc.) of a similarity between the search query 402 and the channel-specific feature 426. The embedding similarity score 412, for example, may include a semantic similarity measure between the embedding representation 406 and/or the source embedding attribute 414 of the channel-specific feature 426. The embedding similarity score 412 may include any embedding distance calculation, such as cosine similarity scores, and/or the like, and/or any other embedding similarity comparison.

In some embodiments, an intermediate query resolution 420 for the search query 402 is generated based on a plurality of aggregated similarity scores 418 for the search query 402.

In some examples, an intermediate query resolution 420 may be indicative (e.g., include feature identifiers, textual descriptions, etc.) of a particular channel-specific feature of the plurality of channel-specific features 426. For example, the intermediate query resolution 420 may be based on an aggregated similarity score 418 between (i) the keyword similarity score 408 that corresponds to the source text attribute 410 for the particular channel-specific feature and (ii) the embedding similarity score 412 that corresponds to the source embedding attribute 414 for the particular channel-specific feature 426.

In some examples, the intermediate query resolution 420 may include one or more channel-specific features from one or more of the other domain channels 430. For example, each respective channel-specific feature of the one or more channel-specific features may correspond to a respective domain channel of the plurality of domain channels (e.g., domain channel 424, other domain channels 430, etc.).

In some embodiments, each of the plurality of aggregated similarity scores 418 include a weighted combination of (i) a keyword similarity score of the plurality of keyword similarity scores 408 and/or (ii) an embedding similarity score of the plurality of embedding similarity scores 412.

In some embodiments, an aggregated similarity score 418 is a measure of similarity between a search query 402 and a source feature. For example, the aggregated similarity score 418 may include a measure of similarity that is aggregated from one or more disparate similarity scores between a search query 402 and a channel-specific feature 426. In some examples, the aggregated similarity score 418 may include a weighted sum, product, and/or the like of matching scores (e.g., keyword similarity scores 408, embedding similarity scores 412, etc.) for the channel-specific feature 426. By way of example, the keyword representation 404 and the embedding representation 406 that match with a corresponding channel-specific feature 426 within a domain channel 424 may be leveraged to generate a plurality of complementary similarity scores, such as keyword similarity score 408 and embedding similarity score 412, for the channel-specific feature 426. The complementary similarity scores may be aggregated using a weighted sum, product, and/or the like to generate the aggregated similarity score 418 that may be used as a final relevance score between the search query 402 and the channel-specific feature 426 and/or domain channel 424. In this way, keyword matching techniques may be leveraged to capture literal similarities, while matching on embeddings captures semantic and contextual similarities between the search query 402 and the channel-specific feature 426. This unique combination takes advantage of both keyword search and embedding technologies to better capture relationships between multiple domain channels (e.g., clinical conditions, specialties, and services, etc. in a clinical domain) in a complex search domain.

In some embodiments, an intermediate query resolution 420 is a data entity that describes one or more source features corresponding to the search query 402. For example, an intermediate query resolution 420 may include an output of a first stage of a multi-stage search process. The intermediate query resolution 420, for example, may identify a plurality of source features from one or more domain channels 424 and/or other domain channels 430 for the search query 402. In some examples, a second stage of a multi-stage search process may be performed to generate the query resolution 422 based on the source features identified by the intermediate query resolution 420. In some examples, the second stage may be performed automatically. In addition, or alternatively, the second stage may be performed based on a selection of a user (e.g., selection of an intermediate query resolution 420, etc.).

In some embodiments, data indicative (e.g., include entity/attribute/feature identifiers, textual/pictorial descriptions, etc.) of the query resolution 422 is provided based on the intermediate query resolution 420. The query resolution 422, for example, may be indicative (e.g., include an entity identifier, textual description, etc.) of particular query result data object of the plurality of query result data objects 428. In some examples, the data indicative (e.g., include entity/attribute/feature identifiers, textual/pictorial descriptions, etc.) of the query resolution 422 may identify a particular query result data object and/or one or more channel-specific features 426 that correspond to the intermediate query resolution 420.

In some embodiments, a query resolution 422 is a data entity that describes one or more query result data objects corresponding to the search query 402. For example, the query resolution 422 may identify one or more query result data objects 360 (and/or one or more source features thereof) for the search query 402. In some examples, the query resolution 422 may include an output of a second stage of a multi-stage search process. The query resolution 422, for example, may identify one or more query result data objects 360 for the search query 402 based on a plurality of source features identified by the intermediate query resolution 420. By way of example, the query resolution 422 may include one or more query result data objects 360 that correspond to one or more source features (e.g., providers that may treat an identified condition, provide a service, practice in a specialty, etc.) identified from one or more of the domain channels 424 and/or other domain channels 430 of the search domain.

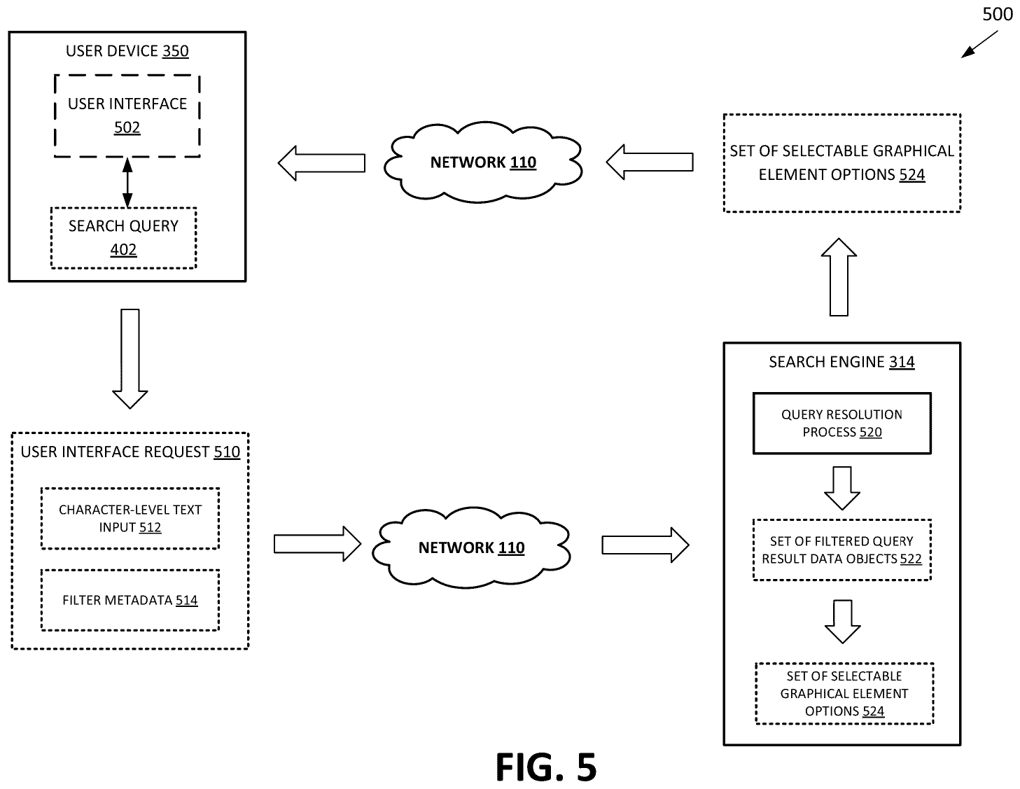

In some embodiments, the search engine 314 is configured to generate a set of filtered query result data objects related to the query result data objects 360 using one or more multi-modal searching techniques. In some embodiments, a set of selectable graphical element options for rendering via a user interface may be generated based on the set of filtered query result data objects. An example of an interactive map-based visualization technique for generating a set of filtered query result data objects and/or a set of selectable graphical element options associated therewith will now further be described with reference to FIG. 5.

FIG. 5 is an interactive map-based visualization system 500 showing example devices, systems, engines, data structures, and/or processes for generating a query resolution for rendering via a user interface in accordance with some embodiments discussed herein.

In some embodiments, the search query 402 is generated via a user interface 502 of the user device 350. The user interface 502 may be an electronic interface for a web page, a mobile application, an electronic portal, a chatbox (e.g., an LLM-based chatbox), and/or the like. Additionally, a user interface request 510 associated with the search query 402 may be generated by the user device 350. In some embodiments, one or more portions of the search query 402 may be transformed into the one or more portions of the user interface request 510. In some embodiments, one or more portions of the search query 402 may be encoded into the user interface request 510 along with other data to facilitate a multi-channel multi-modal search query resolution. The user device 350 may transmit the user interface request 510 to the search engine 314 via the network 110 or another network.

In some embodiments, the user interface request 510 includes character-level text input 512 and/or filter metadata 514. The character-level text input 512 may include a structured and/or natural language sequence of text (e.g., one or more alphanumeric characters, symbols, etc.). In some examples, the character-level text input 512 may include user input, such as text input and/or text generated from one or more audio, tactile, and/or like inputs related to the user interface 502. In some examples, the character-level text input 512 may include a natural language sequence of text provided via the user interface 502. In some examples, character-level text input 512 may include a natural language sequence of text that expresses a question, preference, and/or the like. Additionally or alternatively, the character-level text input 512 may include one or more contextual query attributes for constraining a result for the natural language sequence of text.

The filter metadata 514 may include one or more data items or elements that may be utilized to filter query result data objects (e.g., the query result data objects 360) related to the user interface request 510. In some embodiments, the filter metadata 514 may include one or more contextual query attributes such as, for example, a location attribute (e.g., a GPS position, a latitude/longitude, etc.), one or more structured filters (e.g., selected categories, etc.), one or more user requested filters, and/or the like. For example, the filter metadata 514 may include user location data. The filter metadata 514 may additionally or alternatively include a set of user requested filters selected via the user interface 502. The user location data may include a real-time location approximation associated with the user device 350, data (e.g., a GPS position, a latitude/longitude, etc.) provided by a location module of the user device 350, data associated with a network connection (e.g., a 5G connection, an internet protocol (IP) address, etc.) associated with the user device 350, data based on location text input provided by a user via the user interface 502, a geofence location associated with the user device 350, and/or other location data associated with the user device 350.

In some embodiments, the search engine 314 receives the user interface request 510 via the network 110. For example, the search engine 314 may receive the user interface request 510 via the conversational search interface 320 and/or the textual search interface 322 of the search engine 314. In some embodiments, the search engine 314 may utilize the character-level text input 512 and/or the filter metadata 514 to perform a query resolution process 520 for the search query 402. The query resolution process 520 may correspond to one or more portions of the dataflow diagram 400 illustrated in FIG. 4. The query resolution process 520 may additionally or alternatively correspond to one or more portions and/or techniques related to the search engine 314.

In some embodiments, the query resolution process 520 generates a set of query result data objects (e.g., one or more of the query result data objects 360) for the user interface request 510 by correlating the character-level text input 512 to at least one domain knowledge profile of the domain knowledge datastore 302. The domain knowledge profile may be a profile for an entity that includes a plurality of source features corresponding to the entity. The entity may depend on the search domain. As one example, in a clinical domain, an entity may be a healthcare provider (e.g., facility, practitioner, medical group, etc.) and the domain knowledge profile may be a provider profile identifying a plurality of source features corresponding to the healthcare provider. The plurality of source features may be related to provider data such as, but not limited to, provider taxonomy codes, provider specialty, a provider identifier, a provider location, and/or other provider data.

In some embodiments, the query resolution process 520 additionally or alternatively generates a set of filtered query result data objects 522 for the user interface request 510 by filtering the set of query result data objects using the filter metadata 514. For example, the query resolution process 520 additionally or alternatively generates a set of filtered query result data objects 522 for the user interface request 510 by filtering the set of query result data objects using the user location data and/or the set of user requested filters of the filter metadata 514. The set of filtered query result data objects 522 may correspond to a filtered portion of the query result data objects 360 based on the filter metadata 514. In some embodiments, the query resolution process 520 filters the set of query result data objects based on geolocation points and converts the geolocation points to map marker indicators for plotting via a real-time map visualization.

In some embodiments, the query resolution process 520 additionally or alternatively generates a set of selectable graphical element options 524 for the user interface 502 based on the filtered query result data objects 522. The set of selectable graphical element options 524 may be a formatted version of the set of filtered query result data objects 522 to provide a visualization and/or human interpretation of data associated with the set of filtered query result data objects 522 via the user interface 502. In some embodiments set of selectable graphical element options 524 may be formatted for transmission via the network 110. For example, the set of selectable graphical element options 524 may be formatted for transmission via an API, a communication channel, a communication interface, or combinations thereof. In one or more embodiments, a selectable graphical element option of the s set of selectable graphical element options 524 may include one or more graphical elements and/or one or more textual elements that may be selectable and/or otherwise interacted with via the user interface 502.

In some embodiments, the search engine 314 transmits the set of selectable graphical element options 524 to the user device 350 via the network 110. In some embodiments, the search engine 314 initiates a rendering of the set of selectable graphical element options 524 via the user interface 502 of the user device 350. In some embodiments, the set of selectable graphical element options 524 may be correlated to a real-time map visualization displayed via the user interface 502. In various embodiments, the search engine 314 performs the query resolution process 520 such that the set of selectable graphical element options 524 are rendered via the user interface 502 within 40 milliseconds or approximately 40 milliseconds with respect to generation of the user interface request 510 by the user device 350. As such, an efficient and cost-effective query search may be provided for the user device 350 by utilizing the search engine 314 to perform the query resolution process 520.

In some embodiments, in response to receiving a user interface interaction associated with the set of selectable graphical element options 524 rendered via the user interface 502, the search engine 314 and/or the user device 350 may initiate a rendering of visual data indicative (e.g., representing, including a time and/or distance identifier, etc.) of a distance and/or time between a real-time location of the user device 350 and a map location associated with a respective selectable graphical element option of the set of selectable graphical element options 524. For example, in response to receiving a user interface interaction associated with a particular selectable graphical element option related to a particular domain knowledge profile, the search engine 314 and/or the user device 350 may initiate a rendering of visual data indicative (e.g., representing, including a time and/or distance identifier, etc.) of a distance and/or time between a real-time location of the user device 350 and a map location (e.g., a provider location) for the particular domain knowledge profile associated with the particular selectable graphical element option.

In some embodiments, the search engine 314 and/or the user device 350 may initiate a modification to a visual scale associated with the real-time map visualization of the user interface 502 based on respective map locations for each selectable graphical element option of the set of selectable graphical element options 524. For example, the set of selectable graphical element options 524 may be presented asynchronously when user typing or speaking stops via a search query input of the user interface 502. In some embodiments, the set of selectable graphical element options 524 may be segregated for each category (e.g., entity, provider, facility, etc.) and search result snapshots (e.g., names, addresses, Haversine distance to the user location) may be presented in a dropdown box as selectable options via the respective selectable graphical element options 524. Additionally, search results related to the respective selectable graphical element options 524 may be visualized in the map as markers (e.g., visual indicators) along with a current location of the user device 350 to assist user with estimating traveling distance and/or time between the current location of the user device3 350 and a map location for an entity associated with a particular selectable graphical element option 524. Accordingly, in some embodiments, a Haversine distance between the markers may be calculated to automatically scale the real-time map visualization via the user interface 502 such that all makers are visible and appropriate for visualization via the user interface 502. For example, the center of the scaled version of the real-time map visualization may be based on an average of latitude and longitude points related to the respective knowledge domain profiles associated with the selectable graphical element options 524. Additionally or alternatively, a zoom factor for the real-time map visualization may be based on a Haversine distance for the latitude and longitude points related to the respective knowledge domain profiles associated with the selectable graphical element options 524. In some embodiments, by interacting with the real-time map visualization, a user of the user device 350 may select a marker to obtain detailed information related to a particular domain knowledge profile associated with a particular selectable graphical element option 524. In some embodiments, the detailed information related to a particular domain knowledge profile may be provided in an interactive graphical element (e.g., a pop-up page) on the user interface 502 to allow further actions and/or completion of the search query 402.

In some embodiments, a user of the user device 350 may select a particular position on the real-time map visualization to initiate a new search query and/or a new user interactive request. The particular position on the real-time map visualization may become the center visualization for the new search query and/or new user interactive request. If selected, a marker may allow a user to navigate to a location associated particular selectable graphical element option 524 without removing the initial search results related to the set of particular selectable graphical element options 524 in a list or from the real-time map visualization rendered via the user interface 502. Accordingly, an improved search and navigation process may be provided via the user interface 502 such that different results may be compared against other results and related navigation instructions may be initiated via the user interface 502. In this regard, in some embodiments, the user interface request 510 may be a second user interface request that includes second character-level text input related to a new search query and/or map location data associated with a user interaction with respect to the real-time map visualization. Additionally, the search engine 314 may generate an updated set of query result data objects based on the second character-level text input. The search engine 314 may also initiate, via the user interface 502, a rendering of an updated set of selectable graphical element options based on the updated set of query result data objects.

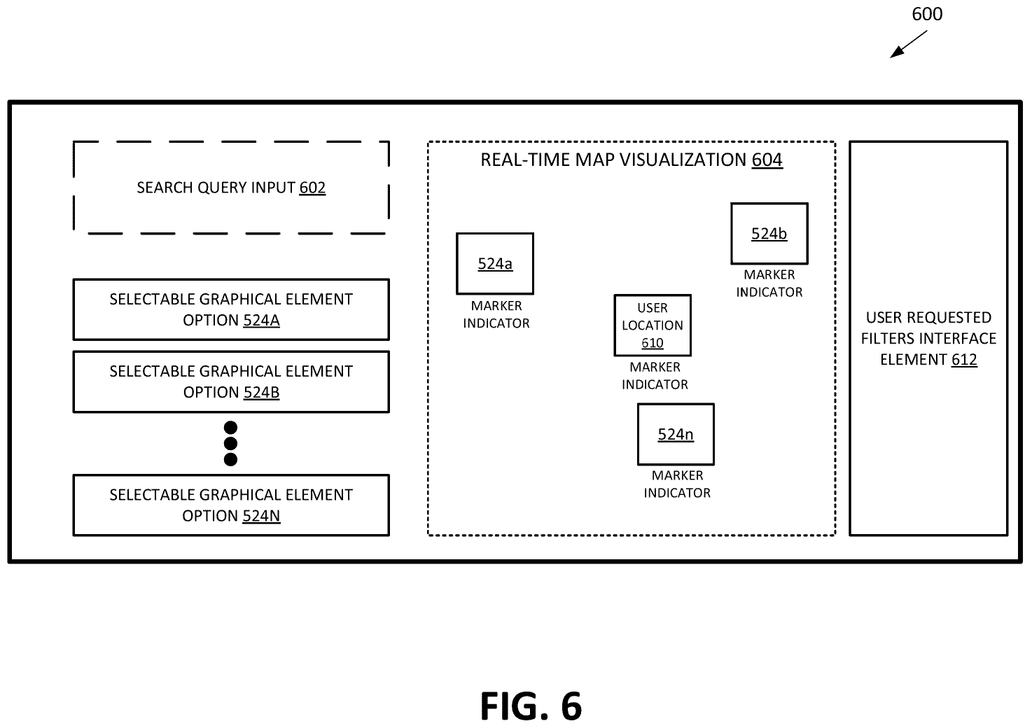

FIG. 6 illustrates an example user interface 600 for providing an interactive map-based visualization related to a query search, in accordance with one or more embodiments of the present disclosure. In one or more embodiments, the user interface 600 is, for example, an electronic interface (e.g., a graphical user interface) of external computing entity 112. For example, the user interface 600 may correspond to the user interface 502 of the user device 350. In various embodiments, the user interface 600 may be provided via external entity output device 220 (e.g., a display) of the external computing entity 112. The user interface 600 may be configured to render a real-time map visualization 604. In various embodiments, the real-time map visualization 604 may provide a visualization based on a set of selectable graphical element options such as the set of selectable graphical element options 524. In a non-limiting example as illustrated in FIG. 6, the set of selectable graphical element options 524 may include a first selectable graphical element option 524a, a second selectable graphical element option 524b, and a third selectable graphical element option 524n.

In some embodiments, the user interface 600 includes search query input 602. The search query input 602 may be configured to receive a search query such as the search query 402. For example, the character-level text input 512 and/or information associated with the search query 402 may be input via the search query input 602 using tactile input, audio input, and/or like inputs. In some embodiments, the user interface 600 additionally includes a user requested filters interface element 612 to allow a user to select one or more filter options (e.g., user requested filters) for the search query provided via the search query input 602. For example, the user requested filters interface element 612 may include one or more filter options related to a type of data source, search domain parameters, user preferences, location preferences, entity preferences (e.g., provider specialty, etc.), and/or another type of filter option.

In response to the search query provided via the search query input 602 and/or one or more filter options selected via the user requested filters interface element 612, the set of selectable graphical element options 524 (e.g., the first selectable graphical element option 524a, the second selectable graphical element option 524b, and the third selectable graphical element option 524n) may be received from the search engine 314. The set of selectable graphical element options 524 may be rendered via a first area of the user interface as a list or other grouping of selectable graphical elements. Additionally, the set of selectable graphical element options 524 may be rendered via a second area of the user interface as respective marker indicators for the real-time map visualization 604. For example, a rendering of the first selectable graphical element option 524a, the second selectable graphical element option 524b, and the third selectable graphical element option 524n via a list format of the user interface 502 may be correlated to the real-time map visualization 604 such that respective marker indicators for the first selectable graphical element option 524a, the second selectable graphical element option 524b, and the third selectable graphical element option 524n are also rendered via the real-time map visualization 604. In some embodiments, the real-time map visualization 604 may additionally render a marker indicator for a user location 610 associated with a user device and/or a user identity related to the search query via the search query input 602.

The set of selectable graphical element options 524 and/or related marker indicators may be respectively configured for user interaction to provide entity information related to respective filtered query result data objects for the selectable graphical element options.

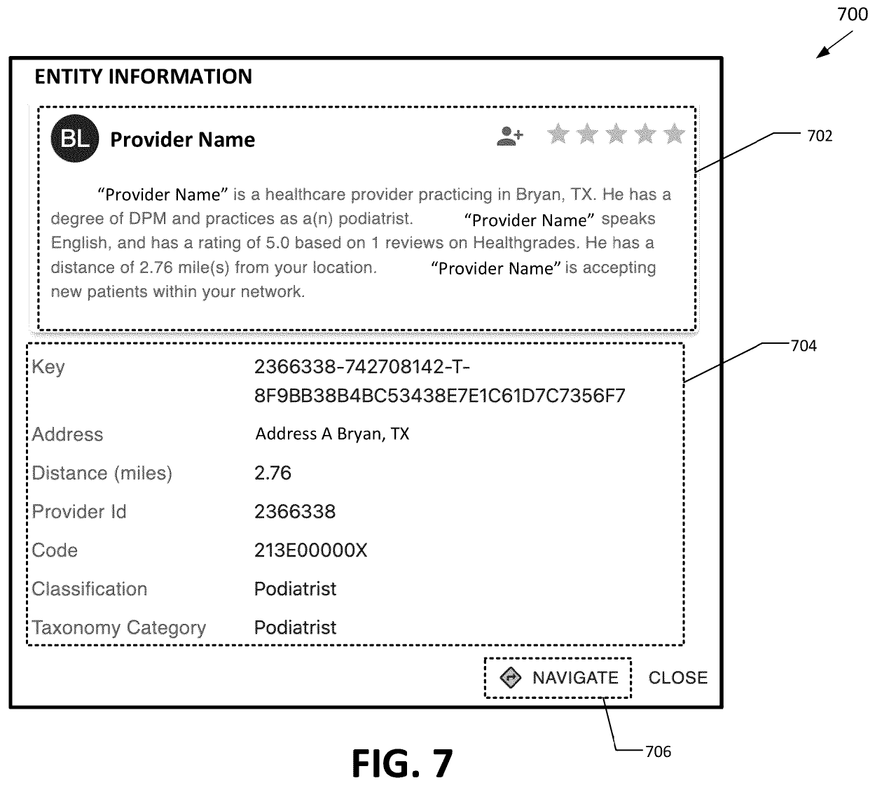

FIG. 7 illustrates an example user interface element 700 for providing entity information related to a selectable graphical element option and/or a related marker indicator, in accordance with one or more embodiments of the present disclosure. For example, the user interface element 700 may be rendered via the user interface 600 in response to selection of a particular selectable graphical element option from set of selectable graphical element options 524 via the user interface 600. In another example, the user interface element 700 may be rendered via the user interface 600 in response to selection of a particular marker indicator correlated to a particular selectable graphical element option from set of selectable graphical element options 524 via the real-time map visualization 604. The user interface element 700 may include an entity information section 702 related to a summary for an entity as provided by a respective domain knowledge profile. The user interface element 700 may additionally or alternatively include an entity information section 704 related to a list of features for an entity as provided by a respective domain knowledge profile. In some examples, the entity information section 702 and/or the entity information section 704 includes provider information for a healthcare provider with a practice at a particular location and/or for a particular provider classification.

The user interface element 700 may additionally or alternatively include a navigation interface element 706 that may be selectable via the user interface 600 to initiate display of a navigation route via the real-time map visualization. For example, the navigation route initiated by the navigation interface element 706 may begin at the user location 610 and may end at a particular location associated with the entity for the user interface element 700 correlated to the particular selectable graphical element option from set of selectable graphical element options 524.

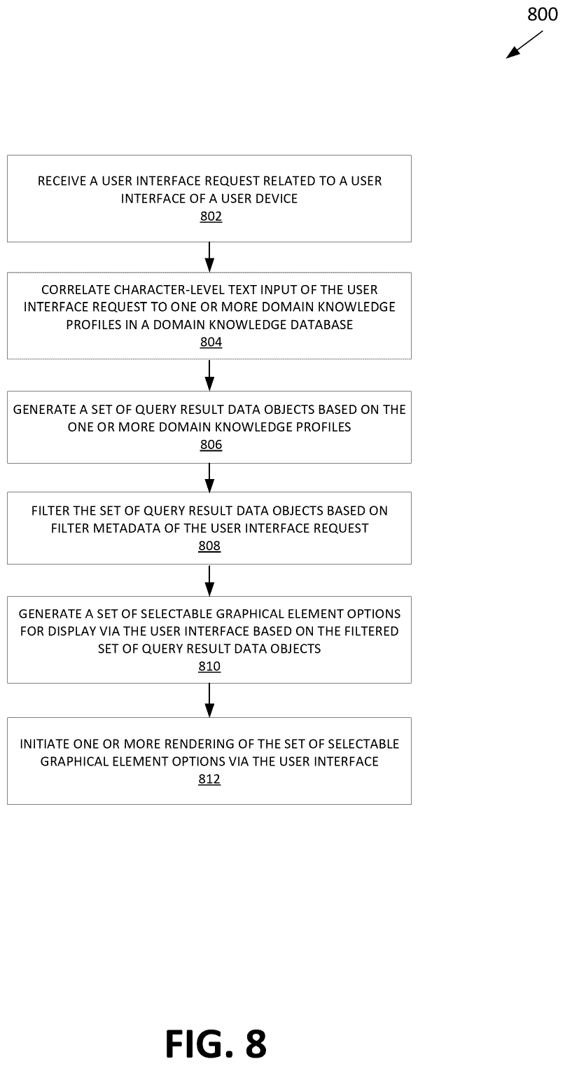

FIG. 8 is a flowchart showing an example of a process 800 for providing interactive user interface visualizations related to multi-channel search for complex domains in accordance with some embodiments discussed herein. The process 800 provides for improving query resolutions with respect to traditional query resolution techniques by aggregating and/or filtering insights for a search query. The process 800 may be implemented by one or more computing devices, entities, and/or systems described herein. For example, via the various steps/operations of the process 800, the computing system 100 may leverage improved query resolution techniques to generate comprehensive query resolutions for rendering via a user interface, while reducing null results and tailoring search results to contextual details underlying a search query. By way of example, unlike traditional query resolution techniques, the query resolution techniques may be capable of aggregating and/or filtering insights that holistically account for multiple aspects of a searches in a complex search domain. The insights may also be configured in a specialized manner to facilitate optimal rendering of visual data for the insights via the user interface.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes, at step/operation 802, receiving a user interface request related to a user interface of a user device. In some embodiments, the user interface request includes (i) character-level text input related to a search query via the user interface and (ii) filter metadata for a user identifier associated with the user interface request.

In some embodiments, the process 800 includes, at step/operation 804, correlating character-level text input of the user interface request to one or more domain knowledge profiles in a domain knowledge database. A domain knowledge profile may include a plurality of features corresponding to the particular domain and/or entity. In some examples, a domain knowledge profile may include a provider profile identifying a plurality of source features corresponding to the healthcare provider.

In some embodiments, the process 800 includes, at step/operation 806, generating a set of query result data objects based on the one or more domain knowledge profiles. A query result data object may be indicative (e.g., include an entity identifier, textual description, etc.) of an entity that is associated with one or more source features from a respective domain knowledge profile from the domain knowledge datastore. By way of example, a query result data object may include a domain knowledge profile for an entity that includes a plurality of source features corresponding to the entity. The entity may depend on the search domain. As one example, in a clinical domain, an entity may be a healthcare provider (e.g., facility, practitioner, medical group, etc.).

In some embodiments, the process 800 includes, at step/operation 808, filtering the set of query result data objects based on filter metadata of the user interface request. In some examples, the filter metadata includes user location data and/or a set of user requested filters. In some examples, the set of user requested filters may be selected via the user interface.

In some embodiments, the process 800 includes, at step/operation 810, generating a set of selectable graphical element options for display via the user interface based on the filtered set of query result data objects. A selectable graphical element option may be a formatted version of a particular filtered query result data object to provide a visualization and/or human interpretation of data associated with the particular filtered query result data objects via the user interface.

In some embodiments, the process 800 includes, at step/operation 812, initiating one or more rendering of the set of selectable graphical element options via the user interface. In some embodiments, the set of selectable graphical element options may be correlated to a real-time map visualization. Additionally, the set of selectable graphical element options may be indicative (e.g., including one or more filtered query visual representation, one or more filtered query identifiers, etc.) of information included in a respective filtered query result data object.

Some techniques of the present disclosure enable the generation of action outputs that may be performed to initiate one or more prediction-based actions to achieve real-world effects. The computer interpretation techniques of the present disclosure may be used, applied, and/or otherwise leveraged to generate enhanced query resolutions, which may help in the interpretation and resolution of search queries. The enhanced query resolutions of the present disclosure may be leveraged to initiate the performance of various computing tasks that improve the performance of a computing system (e.g., a computer itself, etc.) with respect to various prediction-based actions performed by the computing system 100, such as for the resolution of search queries and/or the like. Example prediction-based actions may include the display, transmission, and/or the like of comprehensive data tailored to a user input, such as a query input, a conversational input, and/or the like. Moreover, one or more prediction-based actions may be derived from such comprehensive data, such as the identification of a condition (e.g., medical condition, and/or the like) for which a prediction-based action may be initiated to automatically address. In some embodiments, these prediction-based actions may be leveraged to initiate the performance of various computing tasks that improve the performance and/or security of a computing system (e.g., a computer itself, etc.) with respect to various actions performed by the computing system.

In some examples, the computing tasks may include prediction-based actions that may be based on a search domain. A search domain may include any environment in which computing systems may be applied to achieve real-word insights, such as search predictions (e.g., query resolutions, etc.), and initiate the performance of computing tasks, such as prediction-based actions to act on the real-world insights (e.g., derived from query resolutions, etc.). These prediction-based actions may cause real-world changes, for example, by controlling a hardware component, providing alerts, interactive actions, and/or the like.

Examples of search domains may include financial systems, clinical systems, autonomous systems, robotic systems, and/or the like. Prediction-based actions in such domains may include the initiation of automated instructions across and between devices, automated notifications, automated scheduling operations, automated precautionary actions, automated security actions, automated data processing actions, and/or the like.

In some embodiments, the query processing techniques of the process 800 are applied to initiate the performance of one or more prediction-based actions. A prediction-based action may depend on the search domain. In some examples, the computing system 100 may leverage the multi-modal query processing and/or the multi-stage query resolution techniques to initiate the resolution of a search query, and/or the like.

In some examples, the computing tasks may include actions that may be based on a prediction domain. A prediction domain may include any environment in which computing systems may be applied to achieve real-word insights, such as insights related to query result data objects, and initiate the performance of computing tasks, such as actions, to act on the real-world insights. These actions may cause real-world changes, for example, by controlling a hardware component of a user device, modifying and/or optimizing presentation of visual elements via a user interface, configuring and rendering a real-time map visualization, providing interactive graphical elements via an electronic interface, automatically allocating computing resources for a user device, optimizing data storage or data sources for a user device, and/or the like.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising receiving, by one or more processors, a user interface request that comprises (i) character-level text input related to a search query via a user interface of a user device and (ii) filter metadata for a user identifier associated with the user interface request; generating, by the one or more processors, a set of query result data objects for the user interface request by correlating the character-level text input to at least one domain knowledge profile; generating, by the one or more processors, a set of filtered query result data objects for the user interface request by filtering the set of query result data objects using the filter metadata; and initiating, by the one or more processors and via the user interface of the user device, a rendering of a set of selectable graphical element options that are correlated to a real-time map visualization and indicative of the set of filtered query result data objects.
Example 2. The computer-implemented method of example 1, wherein the filter metadata comprises user location data associated with the user device, and wherein generating the set of query result data objects comprises: filtering the set of query result data objects based on the user location data to generate the set of filtered query result data objects.
Example 3. The computer-implemented method of example 2, wherein the user location data is based on location text input.
Example 4. The computer-implemented method of example 2, wherein the user location data comprises a real-time location approximation associated with the user device.
Example 5. The computer-implemented method of example 2, wherein the user location data comprises a geofence location associated with the user device.
Example 6. The computer-implemented method of any of the preceding examples, wherein the filter metadata comprises a set of user requested filters selected via the user interface, and wherein filtering the set of query result data objects comprises: filtering the set of query result data objects based on the set of user requested filters to generate the set of filtered query result data objects.
Example 7. The computer-implemented method of any of the preceding examples, wherein the filter metadata comprises (a) user location data associated with the user device and (b) a set of user requested filters selected via the user interface, and wherein filtering the set of query result data objects comprises: filtering the set of query result data objects based on (a) the user location data and (b) the set of user requested filters to generate the set of filtered query result data objects.
Example 8. The computer-implemented method of any of the preceding examples, the computer-implemented method further comprising: in response to receiving a user interface interaction associated with the set of selectable graphical element options, initiating the rendering of visual data indicative of at least one of a distance or time between a real-time location of the user device and a map location associated with a respective selectable graphical element option.
Example 9. The computer-implemented method of any of the preceding examples, wherein initiating the rendering of the set of selectable graphical element options comprises: initiating a modification to a visual scale associated with the real-time map visualization based on respective map locations for each selectable graphical element option of the set of selectable graphical element options.
Example 10. The computer-implemented method of any of the preceding examples, wherein the user interface request is a first user interface request, the character-level text input is first character-level text input of the search query, and wherein the computer-implemented method further comprise: receiving, via the user interface, a second user interface request that comprises (a) second character-level text input related to the search query and (b) map location data associated with a user interaction with respect to the real-time map visualization; generating an updated set of query result data objects based on the second character-level text input; and initiating, via the user interface of the user device, a rendering of an updated set of selectable graphical element options based on the updated set of query result data objects.
Example 11. A computing system comprising memory and one or more processors communicatively coupled to the memory, the one or more processors configured to receive a user interface request that comprises (i) character-level text input related to a search query via a user interface of a user device and (ii) filter metadata for a user identifier associated with the user interface request; generate a set of query result data objects for the user interface request by correlating the character-level text input to at least one domain knowledge profile; generate a set of filtered query result data objects for the user interface request by filtering the set of query result data objects using the filter metadata; and initiate, via the user interface of the user device, a rendering of a set of selectable graphical element options that are correlated to a real-time map visualization and indicative of the set of filtered query result data objects.
Example 12. The computing system of example 11, wherein the filter metadata comprises user location data associated with the user device, and the one or more processors further configured to: filter the set of query result data objects based on the user location data to generate the set of filtered query result data objects.
Example 13. The computing system of example 12, wherein the user location data is based on location text input.
Example 14. The computing system of example 12, wherein the user location data comprises a real-time location approximation associated with the user device.
Example 15. The computing system of example 12, wherein the user location data comprises a geofence location associated with the user device.
Example 16. The computing system of any of the preceding examples, wherein the filter metadata comprises a set of user requested filters selected via the user interface, and the one or more processors further configured to: filter the set of query result data objects based on the set of user requested filters to generate the set of filtered query result data objects.
Example 17. The computing system of any of the preceding examples, wherein the filter metadata comprises (a) user location data associated with the user device and (b) a set of user requested filters selected via the user interface, and the one or more processors further configured to: filter the set of query result data objects based on (a) the user location data and (b) the set of user requested filters to generate the set of filtered query result data objects.
Example 18. One or more non-transitory computer-readable storage media including instructions that, when executed by one or more processors, cause the one or more processors to receive a user interface request that comprises (i) character-level text input related to a search query via a user interface of a user device and (ii) filter metadata for a user identifier associated with the user interface request; generate a set of query result data objects for the user interface request by correlating the character-level text input to at least one domain knowledge profile; generate a set of filtered query result data objects for the user interface request by filtering the set of query result data objects using the filter metadata; and initiate, via the user interface of the user device, a rendering of a set of selectable graphical element options that are correlated to a real-time map visualization and indicative of the set of filtered query result data objects.
Example 19. The one or more non-transitory computer-readable storage media of example 19, wherein the filter metadata comprises user location data associated with the user device, and the one or more processors are further caused to: filter the set of query result data objects based on the user location data to generate the set of filtered query result data objects.
Example 20. The one or more non-transitory computer-readable storage media of any of the preceding examples, wherein the filter metadata comprises a set of user requested filters selected via the user interface, and the one or more processors are further caused to: filter the set of query result data objects based on the set of user requested filters to generate the set of filtered query result data objects.

1. A computer-implemented method, the computer-implemented method comprising:
receiving, by one or more processors, a user interface request that comprises (i) character-level text input related to a search query via a user interface of a user device and (ii) filter metadata for a user identifier associated with the user interface request;
generating, by the one or more processors, a set of query result data objects for the user interface request by correlating the character-level text input to at least one domain knowledge profile;
generating, by the one or more processors, a set of filtered query result data objects for the user interface request by filtering the set of query result data objects using the filter metadata; and
initiating, by the one or more processors, a modification to a visual scale associated with a real-time map visualization of the user interface based on respective map locations for a set of selectable graphical element options indicative of the set of filtered query result data objects.

2. The computer-implemented method of claim 1, wherein the filter metadata comprises user location data associated with the user device, and wherein generating the set of query result data objects comprises:
filtering the set of query result data objects based on the user location data to generate the set of filtered query result data objects.

3. The computer-implemented method of claim 2, wherein the user location data is based on location text input.

4. The computer-implemented method of claim 2, wherein the user location data comprises a real-time location approximation associated with the user device.

5. The computer-implemented method of claim 2, wherein the user location data comprises a geofence location associated with the user device.

6. The computer-implemented method of claim 1, wherein the filter metadata comprises a set of user requested filters selected via the user interface, and wherein filtering the set of query result data objects comprises:
filtering the set of query result data objects based on the set of user requested filters to generate the set of filtered query result data objects.

7. The computer-implemented method of claim 1, wherein the filter metadata comprises (a) user location data associated with the user device and (b) a set of user requested filters selected via the user interface, and wherein filtering the set of query result data objects comprises:
filtering the set of query result data objects based on (a) the user location data and (b) the set of user requested filters to generate the set of filtered query result data objects.

8. The computer-implemented method of claim 1, further comprising:
in response to receiving a user interface interaction associated with the set of selectable graphical element options, initiating a rendering of visual data indicative of at least one of a distance or time between a real-time location of the user device and a map location associated with a respective selectable graphical element option.

9. (canceled)

10. The computer-implemented method of claim 1, wherein the user interface request is a first user interface request, the character-level text input is first character-level text input of the search query, and wherein the computer-implemented method further comprises:
receiving, via the user interface, a second user interface request that comprises (a) second character-level text input related to the search query and (b) map location data associated with a user interaction with respect to the real-time map visualization;
generating an updated set of query result data objects based on the second character-level text input; and
initiating, via the user interface of the user device, a rendering of an updated set of selectable graphical element options based on the updated set of query result data objects.

11. A computing system comprising:
one or more processors; and
one or more memories storing processor-executable instructions that, when executed by the one or more processors, cause the one or more processors to perform operations comprising:
receiving a user interface request that comprises (i) character-level text input related to a search query via a user interface of a user device and (ii) filter metadata for a user identifier associated with the user interface request;
generating a set of query result data objects for the user interface request by correlating the character-level text input to at least one domain knowledge profile;
generating a set of filtered query result data objects for the user interface request by filtering the set of query result data objects using the filter metadata; and
initiating a modification to a visual scale associated with a real-time map visualization of the user interface based on respective map locations for a set of selectable graphical element options indicative of the set of filtered query result data objects.

12. The computing system of claim 11, wherein the filter metadata comprises user location data associated with the user device, and the processor-executable instructions, when executed by the one or more processors, further cause the one or more processors to perform operations comprising:
filtering the set of query result data objects based on the user location data to generate the set of filtered query result data objects.

13. The computing system of claim 12, wherein the user location data is based on location text input.

14. The computing system of claim 12, wherein the user location data comprises a real-time location approximation associated with the user device.

15. The computing system of claim 12, wherein the user location data comprises a geofence location associated with the user device.

16. The computing system of claim 11, wherein the filter metadata comprises a set of user requested filters selected via the user interface, and the processor-executable instructions, when executed by the one or more processors, further cause the one or more processors to perform operations comprising:
filtering the set of query result data objects based on the set of user requested filters to generate the set of filtered query result data objects.

17. The computing system of claim 11, wherein the filter metadata comprises (a) user location data associated with the user device and (b) a set of user requested filters selected via the user interface, and the processor-executable instructions, when executed by the one or more processors, further cause the one or more processors to perform operations comprising:
filtering the set of query result data objects based on (a) the user location data and (b) the set of user requested filters to generate the set of filtered query result data objects.

18. One or more non-transitory computer-readable storage media storing processor-executable instructions that, when executed by one or more processors, cause the one or more processors to perform operations comprising:
receiving a user interface request that comprises (i) character-level text input related to a search query via a user interface of a user device and (ii) filter metadata for a user identifier associated with the user interface request;
generating a set of query result data objects for the user interface request by correlating the character-level text input to at least one domain knowledge profile;
generating a set of filtered query result data objects for the user interface request by filtering the set of query result data objects using the filter metadata; and
initiating a modification to a visual scale associated with a real-time map visualization of the user interface based on respective map locations for a set of selectable graphical element options indicative of the set of filtered query result data objects.

19. The one or more non-transitory computer-readable storage media of claim 18, wherein the filter metadata comprises user location data associated with the user device, and the processor-executable instructions, when executed to by the one or more processors, further cause the one or more processors to perform operations comprising:
filtering the set of query result data objects based on the user location data to generate the set of filtered query result data objects.

20. The one or more non-transitory computer-readable storage media of claim 18, wherein the filter metadata comprises a set of user requested filters selected via the user interface, and the processor-executable instructions, when executed to by the one or more processors, further cause the one or more processors to perform operations comprising:
filtering the set of query result data objects based on the set of user requested filters to generate the set of filtered query result data objects.
